(19) United States
(12) Patent Application Publication
(10) Pub. No.: US 2007/0029523 A1
(43) Pub. Date: Feb. 8, 2007

(54) Optical waveguide, optical waveguide apparatus, optomechanical apparatus, detecting apparatus, information processing apparatus, input apparatus, key-input apparatus, and fiber structure

(75) Inventors: Akira Ishibashi, Tokyo (JP); Masayuki Suzuki, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(73) Assignee: SONY CORPORATION

(21) Appl. No.: 11/545,274

(22) Filed: Oct. 10, 2006

Related U.S. Application Data
(62) Division of application No. 10/635,100, filed on Aug. 6, 2003.

(30) Foreign Application Priority Data
Aug. 9, 2002 (JP) JP2002-233197

(51) Int. Cl. C09K 11/02

(52) U.S. Cl. 252/301.36

(57) ABSTRACT

An input apparatus includes a first optical waveguide and a second optical waveguide disposed so as to intersect each other and coupled to each other at the intersection portion. The intersection portion has a stress-luminescent material. When each of the first and second optical waveguides is configured as an optical fiber, the stress-luminescent material is provided in a clad of the optical fiber. The stress-luminescent material is represented by a composite material of SrAl₂O₄:Eu and polyester. The composite material emits luminescence, for example, by contact with a finger with the material, or applying ultrasonic vibration to the material. An optical waveguide apparatus, an optomechanical apparatus, a detecting apparatus, an information processing apparatus, a key-input apparatus, and a fiber structure, each of which uses the stress-luminescent material, are also disclosed.

### BACKGROUND OF THE INVENTION

The present invention relates to an optical waveguide, an optical waveguide apparatus, an optomechanical apparatus, a detecting device, an information processing apparatus, an input apparatus, a key-input apparatus, and a fiber structure, each of which is suitably used for various kinds of electronic equipment.

Input apparatuses of a touch panel type, which have been used for input to electronic equipment such as cash dispensers and computers, are basically classified into an analog capacitive coupling type, an ultrasonic type, a resistance film type, and an infrared type. The analog capacitive coupling type is adapted to uniformly apply a voltage to a glass surface on which a conductive thin film is previously formed by vapor-deposition, thereby detecting a position by a change in voltage by contact of a finger therewith. The ultrasonic type is adapted to detect a position by blocking surface acoustic waves by an elastic absorber. The resistance film type is adapted to detect a position by contact of an object with the surface of an electrode produced by forming a conductive film on glass. The infrared type is adapted to detect a position by blocking an optical path of infrared rays emitted from a light emitting device to a light receiving device.

The related art input apparatus of a touch panel type is insufficient in terms of flexibility and applicability to an enlarged structure. To be more specific, the related art input apparatus of a touch panel type is regarded as a planar patch input apparatus allowing only input to a very narrow region on a flat surface. The input apparatus of this type has another problem that since a large power consumption is required for stand-by, there is a large difficulty in application to an enlarged structure.

### SUMMARY OF THE INVENTION

An object of the present invention is to provide an input apparatus and a key-input apparatus, each of which is flexible and easy to be applied to a large-area structure.

Another object of the present invention is to provide an optical waveguide apparatus, an optomechanical apparatus, a detecting apparatus, an information processing apparatus, and a fiber structure, each of which is flexible and easy to be applied to a large-area structure.

A further object of the present invention is to provide an optical waveguide suitably used for the above-described various apparatuses.

The present inventor has examined to solve the above-described problems, and found that it is effective to use a set of optical waveguides such as optical fibers for an input apparatus, wherein a stress-luminescent material is provided in part of each of the optical waveguides, and the optical waveguides are disposed to intersect each other at an intersection portion at which the stress-luminescent material is present. In this input apparatus, stress is applied to the stress-luminescent material by depressing the intersection portion between the optical waveguides with a finger, to cause the stress-luminescent material to emit luminescence, and the light thus emitted is waveguided in each of the optical waveguides, thereby easily performing various kinds of processing such as inputting or detection of stress by using the light as a signal.

As the stress-luminescent material used for the present invention, there can be used any kind of stress-luminescent material known in the art; however, it is preferred to use a stress-luminescence material capable of causing luminescence emission only by slight contact of a finger of a user therewith, and further, making a ratio in luminescence amount between a state that a pressure is applied to the material and a state that the pressure is released as large as possible.

For example, a stress-luminescent SrAl₂O₄:Eu ceramic having no long-lasting luminescence characteristic can be used as a preferred luminescent material.

A stress-luminescent composite material, which contains the above SrAl₂O₄:Eu ceramic in an amount of 30 wt %. or more and less-than 100 wt %, preferably, 30 wt % or more and 80 wt % or less in a resin can be used as a more preferably luminescent material. In this case, the stress-luminescent material may be formed into a thin sheet.

As the result of detailed examination of the phenomenon that the SrAl₂O₄:Eu ceramic emits luminescence when;stress is applied thereto, as will be described in detail, it has been found that the luminescence emission, more specifically, ON/OFF of the luminescence or the luminous intensity can be controlled by changing the stress applied to the material with elapsed time. This means that, to cause luminescence emission or change the luminous intensity, it is not effective too much to simply apply stress to the material, but it is very effective to give a time rate of change of stress to the material.

On the basis of the above-described examination and knowledge, the present invention has been accomplished.

Accordingly, to achieve the above object, according to a first aspect of the present invention, there is provided an optical waveguide including a stress-luminescent material provided in at least part of the optical waveguide, wherein light emitted from the stress-luminescent material is waveguided in the optical waveguide.

According to a second aspect of the present invention, there is provided an optical waveguide apparatus including a first optical waveguide and a second optical waveguide disposed so as to intersect each other and coupled to each other at the intersection portion, the first optical waveguide and the second optical waveguide being provided in at least part of the optical waveguide apparatus, wherein the intersection portion has a stress-luminescent material.

According to a third aspect of the present invention, there is provided an optomechanical apparatus including a first optical waveguide and a second optical waveguide disposed so as to intersect each other and coupled to each other at the intersection portion, the first optical waveguide and the second optical waveguide being provided in at least part of the optomechanical apparatus, wherein the intersection portion has a stress-luminescent material.

According to a fourth aspect of the present invention, there is provided a detecting apparatus including a first optical waveguide and a second optical waveguide disposed so as to intersect each other and coupled to each other at the intersection portion, the first optical waveguide and the second optical waveguide being provided in at least part of the detecting apparatus, wherein the intersection portion has a stress-luminescent material.

According to a fifth aspect of the present invention, there is provided an information processing apparatus including a first optical waveguide and a second optical waveguide disposed so as to intersect each other and coupled to each other at the intersection portion, the first optical waveguide and the second optical waveguide being provided in at least part of the information processing apparatus, wherein the intersection portion has a stress-luminescent material.

According to a sixth aspect of the present invention, there is provided an input apparatus including a first optical waveguide and a second optical waveguide disposed so as to intersect each other and coupled to each other at the intersection portion, the first optical waveguide and the second optical waveguide being provided in at least part of the input apparatus, wherein the intersection portion has a stress-luminescent material.

According to a seventh aspect of the present invention, there is provided a key-input apparatus including a plurality of first optical waveguides and a plurality of second optical waveguides disposed so as to intersect each other and coupled to each other at the intersection portions, wherein each of the intersection portions has a stress-luminescent material.

According to an eighth aspect of the present invention, there is provided a fiber structure including a first optical waveguide and a second optical waveguide disposed so as to intersect each other and coupled to each other at the intersection portion, the first optical waveguide and the second optical waveguide being provided in at least part of the fiber structure, wherein the intersection portion has a stress-luminescent material.

According to a ninth aspect of the present invention, there is provided an optical waveguide including an optical waveguide body, and a stress-luminescent element provided in at least part of the optical waveguide body, wherein the stress-luminescent element is made from a stress-luminescent material, and light emitted from the stress-luminescent element is waveguided in the optical waveguide body.

According to a tenth aspect of the present invention, there is provided a stress-luminescent composite material sheet having a thickness of less than 1 mm, containing a SrAl₂O₄:Eu powder as a stress-luminescent material and a polyester resin, wherein the content of the stress-luminescent material is in a range of 30 wt % or more and less than 100 wt %.

According to the present invention, the stress-luminescent material may be provided on a side surface of the optical waveguide. The cross-sectional shape of the optical waveguide is not particularly limited but may be a circular or rectangular shape. One typical example of the optical waveguide is an optical fiber, and in the case of using such an optical fiber, the stress-luminescent material may be provided in a clad of the optical fiber. The stress-luminescent material can be used in any form but may be used in the form of a film or fine particles. To waveguide light emitted from the stress-luminescent material for a short distance, the stress-luminescent material may be provided at any location of the cross-section of the optical waveguide; however, to waveguide light emitted from the stress-luminescent material for a long distance, the stress-luminescent material may be provided in the clad of the optical waveguide as described above.

The numbers, thicknesses, lengths, mutual interval, arrangement of the first and second optical waveguides, and further, the number and arrangement of intersection portions therebetween may be suitably determined depending on the application and function of the apparatus.

A light receiving device may be connected directly or indirectly via an optical fiber to an end face of at least one of the first and second optical waveguides.

According to the present invention, various kinds of the stress-luminescent materials can be used; however, it is preferred to use the following stress-luminescent materials found by the present invention.

(1) A stress-luminescent material composed of a fluorescent material which emits luminescence depending on a time rate of change of stress. The “time rate of change of stress” is expressed by du/dt, where a is stress and “t” is time. It is to be noted that the stress includes not only mechanical stress but also thermal stress.

(2) A stress-luminescent material composed of a fluorescent material which emits luminescence, wherein the luminous intensity is changed depending on a time rate of change of stress.

The time rate of change of stress corresponds to speed of applying an external force to the stress-luminescent material or a speed of releasing the external force.

(3) A stress-luminescent material composed of a fluorescent material which emits luminescence depending on a speed of applying an external force to the stress-luminescent material or a speed of releasing the external force.

(4) A stress-luminescent material composed of a fluorescent material which emits luminescence, wherein the luminous intensity is changed depending on a speed of applying an external force to the stress-luminescent material or a speed of releasing the external force.

(5) A stress-luminescent material composed of a composite material which emits luminescence depending on a time rate of change of stress.

(6) A stress-luminescent material composed of a composite material which emits luminescence, wherein the luminous intensity is changed depending on a time rate of change of stress.

(7) A stress-luminescent material composed of a composite material which emits luminescence depending on a speed of applying an external force to the stress-luminescent material or a speed of releasing the external force.

(8) A stress-luminescent material composed of a composite material which emits luminescence, wherein the luminous intensity is changed depending on a speed of applying an external force to the stress-luminescent material or a speed of releasing the external force.

(9) A stress-luminescent material composed of a composite material containing a fluorescent material and an additional material, which composite material emits luminescence depending on a time rate of change of stress.

(10) A stress-luminescent material composed of a composite material containing a fluorescent material and an additional material, which composite material emits luminescence, wherein the luminous intensity is changed depending on a time rate of change of stress.

(11) A stress-luminescent material composed of a composite material containing a fluorescent material and an additional material, which composite material emits luminescence depending on a speed of applying an external force to the stress-luminescent material or a speed of releasing the external force.

(12) A stress-luminescent material composed of a composite material containing a fluorescent material and an additional material, which composite material emits luminescence, wherein the luminous intensity is changed depending on a speed of applying an external force to the stress-luminescent material or a speed of releasing the external force.

(13) A stress-luminescent material composed of-a fluorescent material which emits luminescence when a finger is touched to the material.

(14) A stress-luminescent material composed of a composite material which emits luminescence when a finger is touched to the material.

The case of causing luminescence emission by touching a finger to the material includes not only a case of causing a time rate of change of stress for the material but also a case of causing displacement of the material for a certain distance as a result of applying a certain force to the material for a specific time.

(15) A stress-luminescent material composed of a composite material containing a fluorescent material and additional material, which composite material emits luminescence when a finger is touched to the material.

(16) A stress-luminescent material composed of a fluorescent material which emits luminescence when elastic vibration is applied to the material.

(17) A stress-luminescent material composed of a composite material which emits luminescence when elastic vibration is applied to the material.

(18) A stress-luminescent material composed of a composite material containing a fluorescent material and an additional material, which composite material emits luminescence when elastic vibration is applied to the material.

It is effective to apply sound waves, particularly, ultrasonic waves to the-material for applying elastic vibration to the material.

(19) A stress-luminescent material composed of a fluorescent material which emits luminescence when sound waves are applied to the material.

(20) A stress-luminescent material composed of a composite material which emits luminescence when sound waves are applied to the material.

(21) A stress-luminescent material composed of a composite material containing a fluorescent material and an additional material, which composite material emits luminescence when sound waves are applied to the material.

(22) A stress-luminescent material composed of a fluorescent material which emits luminescence when ultrasonic waves are applied to the material.

(23) A stress-luminescent material composed of a composite material which emits luminescence when ultrasonic waves are applied to the material.

(24) A stress-luminescent material composed of a composite material containing a fluorescent material and an additional material, which composite material emits luminescence when ultrasonic waves are applied to the material.

The additional material used together with the fluorescent material for forming the composite material may be suitably set depending on the application. One kind or two or more kinds of the additional materials may be used.- The additional material may be either an organic material or an inorganic material. Preferably, from the viewpoint of flexibility, an elastic material is used as the additional material. In this case, the content of the fluorescent material in the elastic material may be set in a range of 30 wt % or more and less than 100 wt %, preferably, 30 wt % or more and 80 wt % or less. The elastic material may have a Young's modulus of 10 MPa or more. The elastic material may be an organic material, which is at least one kind selected from a group consisting of polymethyl methacrylate (PMMA), ABS resin, polycarbonate (PC), polystyrene (PS), polyethylene (PE), polypropylene (PP), polyacetal (PA), urethane resin, polyester, epoxy resin, silicone resin, an organic silicon compound having a siloxane bond, and an organic piezoelectric material. The organic piezoelectric material may be copolymer such as polyvinylidene fluoride (PVDF) or polytrifluoroethylene. The elastic material may be an inorganic material such as inorganic glass.

The fluorescent material may be an oxide containing one of aluminum, gallium, and zinc as a constituting element, preferably, an oxide of an alkali earth metal and aluminum, gallium or zinc, wherein the oxide is doped with a rare earth element. One kind or two or more kinds of rare earth elements may be doped depending on the application. As a typical example of doping one kind of rare earth element, Eu is doped in the fluorescent material. The florescent material doped with Eu is suitable for the application requiring short-lasting characteristic. A preferable fluorescent material doped with Eu is SrAl₂O₄:Eu. A composite material containing SrAl₂O₄:Eu as the fluorescent material and one of polyester, acrylic resin, or a mixture thereof as the elastic material is preferable. As a typical example of doping two kinds of rare earth elements, Eu and Dy are doped in the fluorescent material. The fluorescent material doped with Eu and Dy is suitable for the application requiring long-lasting luminescence characteristic. In addition to an oxide of one of aluminum, gallium, and zinc as a constituting element, a material doped with manganese and/or titanium, for example, ZnS:Mn, ZnS:Ti, or ZnS:Mn,Ti may be used for the fluorescent material.

The shape and dimension of the fluorescent material or composite material may be adjusted depending on the application. If the fluorescent material or composite material is formed into a sheet, from the viewpoint of ensuring flexibility, the thickness of the film may be in a range of 1 mm or less, preferably, 0.5 mm or less. Also, from the viewpoint of ensuring flexibility of the fluorescent material or composite material, the fluorescent material may be formed into a sponge-shape or network shape.

The fluorescent material may contain aluminum and silicon, in addition to aluminum, gallium, or zinc.

As one preferable example, the fluorescent material is crystalline, which used in the form of fine particles each having a diameter of 100 nm or less. A composite material containing such a crystalline fluorescent material and an amorphous elastic material is preferable.

The composite material may be in the form of gel as a whole.

The composite material may be produced by various methods. In particular, in the case of producing a composite material containing a fluorescent material in the form of fine particles each having a diameter of 100 nm or less and an elastic material, dehydration-condensation reaction of a polysiloxane compound and a metal alkoxide may be used.

The additional material used together with the fluorescent material for forming the composite material is exemplified by an organic conductive material deformable by incorporation of ions, for example, a heteroaromatic conductive polymer, more specifically, polypyrrole, polythiophene, or polyaniline. A polymer gel material may be used as the additional material. The polymer gel material may be at least one kind selected from a group consisting of a water-soluble non-electrolytic polymer gel displaceable with the change in heat, an electrolytic polymer gel displaceable with the change in pH, a combination of a polymer compound displaceable with the change in electricity with a surface-active agent, a polyvinyl alcohol material, and a polypyrrole material. The water-soluble non-electrolytic polymer gel having the thermal displacement function is represented by polyvinyl methyl ether or poly n-isopropyl acrylamide; the electrolytic polymer gel displaceable with the change in pH is represented by polyacrylonitrile: and the polymer compound displaceable with the change in electricity is represented by polyacrylamide-2-methyl-propanesulfonic acid.

The fluorescent material can be used for a coating material, paint, ink, artificial skin, or a light emitting device. The fluorescent material may be combined with an additional material as needed, to be thus used as a composite material.

In the case of the composite material for a light emitting device, a piezoelectric transducer, a piezoelectric material, or a surface acoustic wave device is used to apply elastic vibration to the composite material, thereby obtaining a time rate of change of stress. To obtain good crystalline, a thin film made from a piezoelectric material and a thin film made from the composite material are preferably stacked by epitaxial growth in lattice matching with each other. To cause piezoelectric vibration of a thin film made from a piezoelectric material, a pair of opposed electrodes may be disposed in such a manner as to sandwich the piezoelectric thin film, or a pair of opposed comb-shaped electrodes may be disposed on one surface of the piezoelectric thin film, and an electric signal is inputted between these electrodes. In the latter case, luminescence emission can be controlled by providing a transistor for control of luminescence emission, for example, an MIS transistor, and electrically connecting a drain of the MIS transistor to one of the pair of comb shaped electrodes. The light emitting device can be used as one unit of an active matrix system.

The thin film made from a piezoelectric material can be formed on any substrate; however, it is preferably formed on a Si substrate which is inexpensive and easily available. In the case of using the Si substrate, a CeO₂ thin film may be first grown on the Si substrate and then the thin film made from a piezoelectric material may be formed on the CeO₂ thin film. In this case, the piezoelectric thin film can be formed on the CeO₂ thin film by epitaxial growth in lattice-alignment therewith.

The additional material used together with the fluorescent material for forming the composite material may be a piezoelectric material. In a typical example, the composite material has grains and grain boundaries, wherein the grains are mainly made from the piezoelectric material and the grain boundaries are made from the fluorescent material. In a light emitting device using such a composite material, electrodes are provided so as to induce electrostriction by an electric signal inputted from external, thereby causing luminescence emission from the fluorescent material at the grain-boundaries.

A piezoelectric material having an ABO₃ type perovskite crystal structure is typically used, although other piezoelectric materials can be used. More specifically, at least one kind selected from a group consisting of a PbTiO₃ based material, PbZrO₃ based material, Pb(ZrTi)O₃ based material, Pb(ZnNb)O₃ based material, and Pb(MgNb)O₃ based material, or a solid-solution material thereof is preferably used. The combination of the piezoelectric material and the fluorescent material is represented by a combination of Pb(ZrTi)O₃ (piezoelectric material) and SrAl₂O₄:Eu (fluorescent material), or a combination of Pb(ZnNb)O₃ (piezoelectric material) and SrAl₂O₄:Eu (fluorescent material).

The fluorescent material typically has an aluminate based glass phase containing a rare earth element, more specifically, a glass phase containing fine particles of SrAl₂O₄:Eu.

If a composite material contains a fluorescent material and a piezoelectric material, the composite material can be produced by various methods. One preferred method includes a step of melting a mixture containing at least Sr, Al, Eu, and a glass forming material and rapidly cooling the melted mixture to form a glass phase; and a step of pulverizing the glass phase into a powder, mixing the powder with a piezoelectric material, and heat-treating the mixture, thereby precipitating fine particles of SrAl₂O₄ from the glass phase.

A two-dimensional array of light emitting devices can be easily produced by preparing a substrate having an actuator function, and printing ink containing a fluorescent material in dots by using a printer or the like.

The above printing is typically performed by using a printer. The dotted material may be provided on a substrate in a desired pattern, typically, in a periodical pattern. In this case, the light emitting devices each having an actuator function are periodically buried in the substrate surface. The substrate may be a polymer actuator. The polymer actuator is made from at least one kind or more selected from a group consisting of a water-soluble non-electrolytic polymer gel displaceable with the change in heat, an electrolytic polymer gel displaceable with the change in pH, a combination of a polymer compound displaceable with the change in electricity with a surface-active agent, a polyvinyl alcohol material, and a polypyrrole material.

A flexible luminescent material can be obtained by using the above-described fluorescent material or composite material, which is usable as a wearable material. A typical method for forming such a flexible luminescent material includes a step of disposing a material containing a fluorescent material emitting luminescence depending on a time rate of change of stress within a two-dimensional plane of a substrate in the shape of a film, droplets, dots, rod, stripes, or bulk ceramic, to obtain a plurality of base bodies, and a step of connecting the base bodies to each other by flexible connecting means. The luminescent material becomes macroscopically flexible by connecting the base bodies to each other by means of fibers or strings in a manner similar to that used in Japan for producing a traditional armor.

The fluorescent material or composite material can easily emit luminescent by applying ultrasonic waves to the material. Such a fluorescent material sensitive to ultrasonic waves can be produced by various methods. One preferred method involves reducing a crystalline material, for example, an oxide of an alkali earth element and aluminum to which one kind of rare earth element has been doped, at a temperature of 500° C. or more, tothereby obtain a luminescence material sensitive to ultrasonic waves. Such a luminescent material sensitive to ultrasonic waves can be used for a traffic sign making use of luminescence emission.

The fluorescent material according to the present invention can be used for various kinds of electronic equipment having a light emitting display portion, a light emitting system, and a display system. The fluorescent material may be combined with an additional material to form a composite material as needed.

According to the present invention configured as described above, when an intersection portion between the first optical waveguide and a second optical waveguide is pressed by a finger or the like, stress is concentrated at a stress-luminescent material at the intersection portion, to cause the stress-luminescent material to emit luminescence. The light thus emitted is made incident on at least one of the first and second optical waveguides and is waveguided therethrough, to emerge from the end face of the optical waveguide. The light emerged from the end face can be detected by an external light receiving device.

The pressing motion of a finger to an intersection portion between the first and second optical waveguides is taken as an input signal. Accordingly, it is possible to eliminate the need of injecting a current for causing luminescence emission, unlike electroluminescence or emission from a light emitting diode, and hence to essentially reduce power consumption to zero except for power consumption of a light receiving device.

### BRIEF DESCRIPTION OF THE DRAWINGS

These and other objects, features, and advantages of the present invention will become more apparent from the following detailed description in conjunction with the accompanying drawings, wherein:

FIGS. 1 to 4 are schematic diagrams showing X-ray diffraction patterns of a raw material and the material synthesized in sequential steps of a process producing a powder of SrAl₂O₄:Eu ceramic by synthesis using solid reaction;

FIGS. 5A to 5D are photographs illustrating the states of luminescence from a composite material sheet of the present invention when the sheet is bent;

FIG. 6 is a schematic diagram showing an entertainment robot using an artificial skin made from a material which emits luminescence when touched with a finger;

FIG. 7 is a schematic diagram showing a relationship between a content of a SrAl₂O₄:Eu powder in a composite material sheet of the SrAl₂O₄:Eu powder and a polyester resin and a luminous intensity of the composite material sheet;

FIGS. 8A to 8E are photographs showing lasting luminescence characteristics of the composite material sheet (SrAl₂O₄:Eu powder and polyester resin) and a composite material sheet (SrAl₂O₄:Eu+Dy powder and resin);

FIG. 9A is a schematic diagram showing an ultraviolet-excited emission spectrum of the SrAl₂O₄:Eu powder and FIG. 9B is a schematic diagram showing the lasting luminescence characteristic of the SrAl₂O₄:Eu powder;

FIG. 10A is a schematic diagram showing an ultraviolet-excited emission spectrum of the SrAl₂O₄:Eu+Dy powder and FIG. 10B is a schematic diagram showing the lasting luminescence characteristic of the SrAl₂O₄:Eu+Dy powder;

FIG. 11 is a schematic energy band diagram showing luminescence emission of SrAl₂O₄:Eu;

FIGS. 12A to 12E are photographs showing results of observing a reversible luminescence characteristic of the composite material sheet of the present invention by applying a pressure to the sheet and releasing the pressure;

FIGS. 13A to 13C are photographs showing states of luminescence of the composite material sheet of the present invention at the time when the sheet is brought into contact with an ultrasonic-vibrating horn;

FIGS. 14A and 14B are photographs showing states of luminescence of the composite material sheet of the present invention at the time when the sheet placed on an ultrasonic transducer is turned on and off;

FIG. 15 is a schematic conceptual diagram showing an artificial skin system using the composite material of the present invention;

FIG. 16 is a schematic diagram showing an entertainment robot using the artificial skin of the present invention;

FIG. 17 is a schematic diagram showing an artificial luminescent skin using each of sponge-shaped and framework-shaped stress-luminescent materials, to which photographs of-the materials are attached;

FIG. 18 is a schematic diagram showing the structure of an inorganic/organic hybrid material of the present invention;

FIG. 19 is a schematic diagram showing flexibility of a sheet made from the inorganic/organic hybrid material of the present invention;

FIG. 20 is a schematic diagram showing a method of producing a light emitting device using a stress-luminescent material in combination with a piezoelectric material;

FIG. 21 is a schematic diagram showing a method of producing a light emitting device using a stress-luminescent material in combination with a surface acoustic wave material;

FIG. 22 is a sectional view showing a MOSFET integrated light emitting device;

FIG. 23 is a schematic diagram showing a two-dimensional light emitting device using the MOSFET integrated light emitting device shown in FIG. 22, wherein the light emitting device is driven in an active matrix mode;

FIG. 24 is a schematic diagram showing a composite material in which a stress-luminescent material is provided at grain boundaries of fine crystals of a piezoelectric ceramic;

FIGS. 25A and 25B are schematic diagrams illustrating the-operation of a light emitting device using the composite material shown in FIG. 24;

FIG. 26 is a schematic diagram showing a light emitting device produced by forming stress-luminescent dots on an actuator substrate by an ink-jet process;

FIGS. 27A and 27B are schematic diagrams showing a road sign light emitting system using ultrasonic waves;

FIG. 28 is a schematic diagram showing an artificial skin of the present invention;

FIG. 29A is a schematic diagram showing an optical fiber used for an input apparatus according to a first embodiment, and FIGS. 29B to 29D are sectional views showing the optical fiber;

FIG. 30 is a schematic diagram showing the input apparatus according to the first embodiment;

FIG. 31 is a schematic diagram of an intersection portion between the optical fibers of the input apparatus according to the first embodiment of the present invention;

FIG. 32 is a schematic diagram illustrating a method of operating the input apparatus according to the first embodiment of the present invention;

FIG. 33 is a schematic diagram showing changes in luminous intensity and pressure (stress) with elapsed time for the stress-luminescent material of the input apparatus according to the first embodiment of the present invention;

FIG. 34 is a schematic diagram showing a key-input apparatus according to a second embodiment of the present invention;

FIG. 35 is a schematic diagram showing a key-input apparatus according to a third embodiment of the present invention;

FIG. 36 is a schematic diagram showing an optical fiber sheet according to a fourth embodiment of the present invention;

FIG. 37 is a schematic diagram showing a change in pressure with elapsed time for the optical fiber sheet according to the fourth embodiment of the present invention;

FIG. 38 is a schematic diagram showing a change in the number of luminescence points with elapsed time for the optical fiber sheet according to the fourth embodiment of the present invention;

FIG. 39 is a schematic diagram showing a change in the number of groups of luminescence points with elapsed time for the optical fiber sheet according to the fourth embodiment of the present invention;

FIGS. 40A to 40C are schematic diagrams showing an optical fiber sheet system according to a fifth embodiment of the present invention;

FIG. 41 is a schematic diagram showing the optical fiber sheet system according to the fifth embodiment of the present invention;

FIGS. 42A and 42B are schematic diagrams illustrating the operation of the optical fiber sheet system according to the fifth embodiment of the present invention;

FIG. 43 is a schematic diagram showing a manifold in a higher order (n-th order) space;

FIG. 44 is a schematic diagram showing an example in which a metric space is integrated with a non-metric space; and

FIG. 45 is a schematic diagram showing an in-home broadcasting.

### DETAILED DESCRIPTION OF THE PREFERRED EMBODIMENTS

Hereinafter, preferred embodiments of the present invention will be described with reference to the drawings. It is to be noted that like reference numerals denote like and corresponding parts throughout the drawings.

A SrAl₂O₄:Eu based composite material suitably used as a stress-luminescent material in the following preferred embodiments, a method of producing the material, and applications of the material will be described below.

A method of producing a SrAl₂O₄:Eu ceramic by a general solid-phase reaction process will be first described.

Raw materials listed below were mixed at a specific mixing ratio in a ball mill for about 20 hr.
SrCO₃: 0.39 mol=147.6292×0.39=57.575388 g
Al₂O₃: 0.4 mol=101.96128×0.4=40.784512 g
Eu₂O₃: 0.002 mol=351.9182×0.002=0.7038396 g
B₂O₃: 0.032 mol=69.6182×0.032=2.2277824

The mixture was synthesized by subjecting the mixture to calcination in air at 1400° C., calcination in oxygen at 1400° C., and reducing heat-treatment in a H₂ (5%)-N₂ atmosphere at 1300° C.

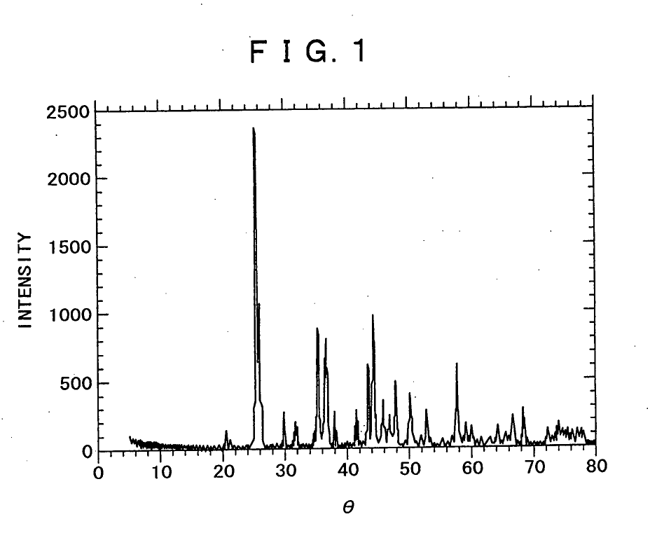

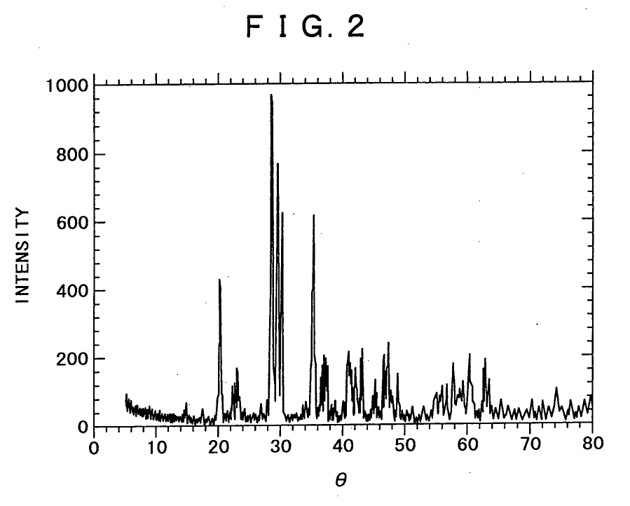

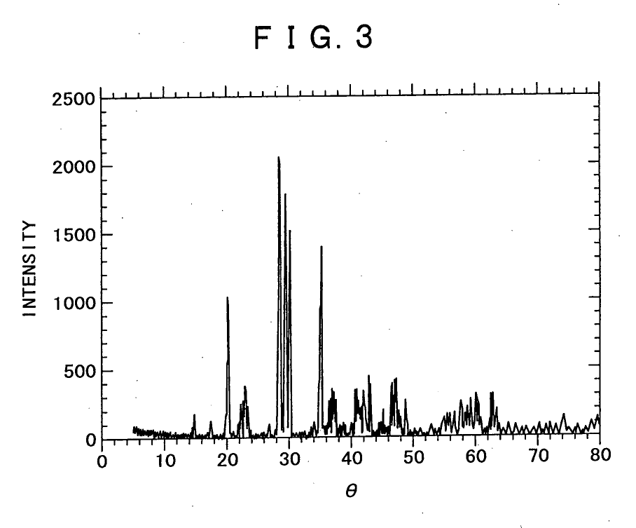

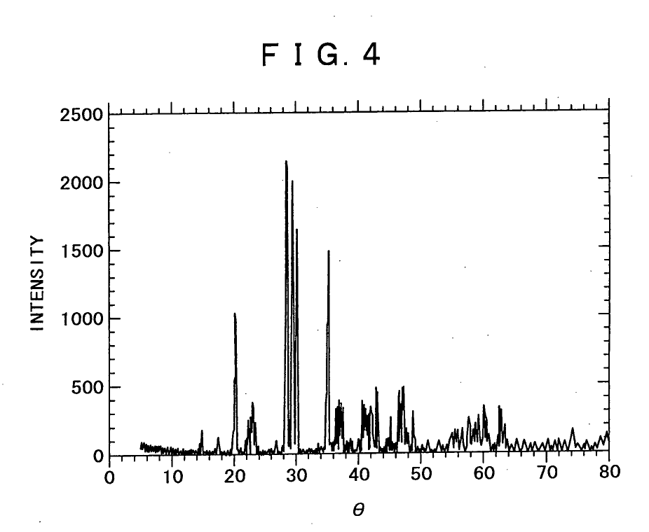

FIG. 1 shows an X-ray diffraction spectrum of the mixture before heat-treatment, FIG. 2 shows an X-ray diffraction spectrum of the mixture after calculation in air at 1400° C. for 2 hr. FIG. 3 shows an X-ray diffraction spectrum of the mixture after calculation in oxygen at 1400° C. for 2 hr, and FIG. 4 shows an X-ray diffraction spectrum of the mixture after reducing heat-treatment in H₂ (5%)-N₂ atmosphere at 1300° C. for 2 hr.

From the results of the X-ray diffraction of the mixture at respective steps, it becomes apparent that a crystal phase nearly close to a target crystal phase was created in the step of calcinations in air at 1400° C. (see FIG. 2), and that the synthesized material had a single-crystal phase entirely indexed with “monoclinic system” as described in a known document “F. Hanic, T. Y. Chemekova and J. Majling, J. Appl. Phys., 12(1979)243”.

The SrAl₂O₄:Eu powder was kneaded with a polyester resin (commercially available from Buehler, Ltd. in the trade name of “Castolite Resin”) at a mixing ratio (wt %) of 1:2, and formed into a sheet having a size of several cm square. The resultant sheet was left for 24 hr, to produce an inorganic/organic composite sheet. The average particle size of a fine powder of SrAl₂O₄:Eu was in a range of 100 nm or less. To the best of the present inventor's knowledge, there is no report on a SrAl₂O₄:Eu composite material using polyester.

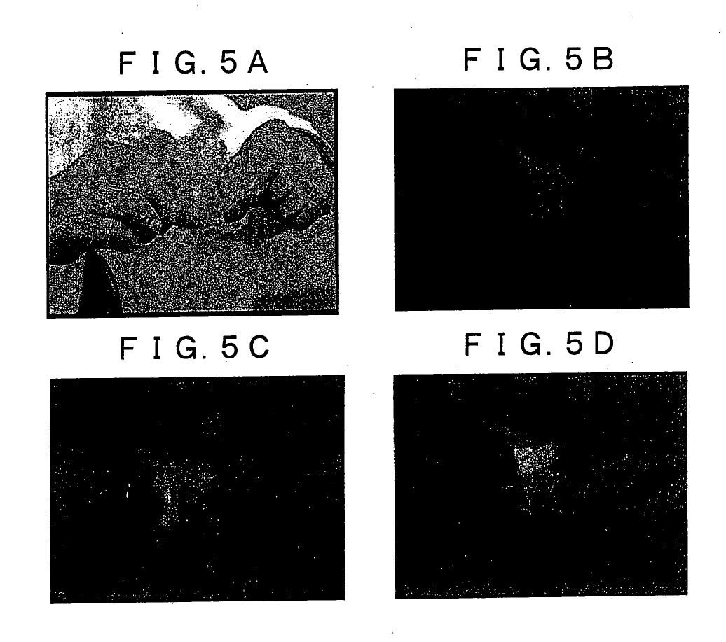

The sheet (shaped into an underlay used as placed under writing paper) thus produced was as thin as less than 1 mm in thickness. When slightly bent, the sheet emits intensive luminescence. The luminescence emission of the sheet is shown in FIGS. 5A to 5D.

FIG. 5A shows a state that the sheet is placed in a bright room while being kept as not bent; FIG. 5B shows a state that the room is darkened and the sheet begins to be bent by an operator with his or her fingers; FIG. 5C shows a state that the sheet is gradually bent with the fingers in the dark room, and a portion of the sheet held by the fingers emits luminescence; and FIG. 5D shows a state that the sheet is bent into two parts in the dark room, and the sheet entirely emits luminescence.

The technique of allowing a stress-luminescent composite material to simply emit luminescence only by the touch of a finger therewith has been unknown until being found by the present inventor.

Stress-luminescent materials have been reported by Jo, Akiyama, and others in Kyushu National Industrial Research Institute. Many of the experimental reports, however, have described a technique in which a mixture of a stress-luminescent material and an epoxy resin is molded into a bulk body, wherein the bulk body emits luminescence when applied with a pressure being as large as several tons. To the best of the present inventor's knowledge, there has been no report on a stress-luminescent composite material, wherein the composite material emits luminescence only by slight touch of a finger therewith.

The above-described inorganic/organic composite sheet obtained by the present inventor, which sheet is able to emit luminescence only by simple bending, is very useful as an artificial skin material, for example, for an entertainment robot.

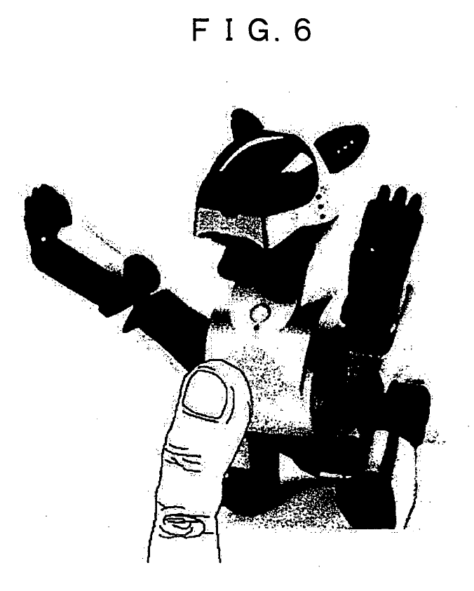

FIG. 6 is a schematic image diagram showing one example of application of the inorganic/organic composite material, wherein the sheet is provided as an artificial skin on a chest portion of a dog-shaped entertainment robot. As shown in this figure, the artificial skin emits luminescence by contact of a finger of a user with the skin.

The inorganic/organic composite sheet developed by the present inventor, which emits luminescence only by slight contact of a finger with the sheet, may be applicable not only to the field of the above-described functional artificial skin but also to other industrial fields.

The mixing ratio (wt %) of the SrAl₂O₄:Eu powder as a stress-luminescent material and a resin material will be described below.

Sheets were produced in the same manner as that described above with the mixing ratio of the SrAl₂O₄:Eu powder and the resin material changed from 10 wt % to 80 wt %. The size of the sheet was set to 10 mm×25 mm, and the thickness thereof was set to about 0.25 mm. As a result of this experiment, the sheet containing 70 wt % or less of the SrAl₂O₄:Eu powder exhibited good mechanical reliability in terms of shape retention, whereas the sheet containing 80 wt % of the SrAl₂O₄:Eu powder was liable to lose its shape, that is, poor in mechanical reliability.

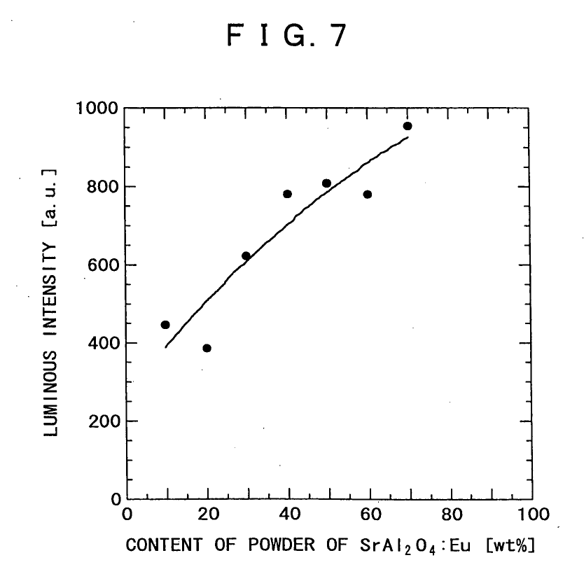

FIG. 7 shows a relationship between the weight ratio (content in weight) of the SrAl₂O₄:Eu powder and the luminous intensity of the sheet. Taking into account luminescence characteristics of the sheet, it is preferred to increase the content of the SrAl₂O₄:Eu powder because the luminous intensity becomes larger with the increased content of the SrAl₂O₄:Eu powder; however, if the sheet is poor in mechanical reliability, such a sheet fails commercialization. From this viewpoint, the content of the SrAl₂O₄:Eu powder is preferably in a range of about 30 to 75%.

It is to be noted that in principle, there may be a room to mold a mixture containing the SrAl₂O₄:Eu powder in an amount of 80% or more into a sheet having good shape retention.

The composite material used herein emits luminescence by stress applied thereto, but in the present situation, it is very difficult to clearly observe the luminescence by the naked eye in a bright environment, for example, in daylight. This is a matter of luminous intensity. If luminescence occurs from the composite material not by stress but by optical excitation, for example, by ultraviolet emission, such luminescence can be clearly observed in daylight; however, luminescence occurring from the composite material by stress cannot be clearly observed in daylight, although it is obscure whether such weak luminescence is due to poor excitation intensity or poor efficiency in luminescence emission. Accordingly, it may be effective to allow the composite material to emit luminescence by stress applied thereto at night or in a dark room.

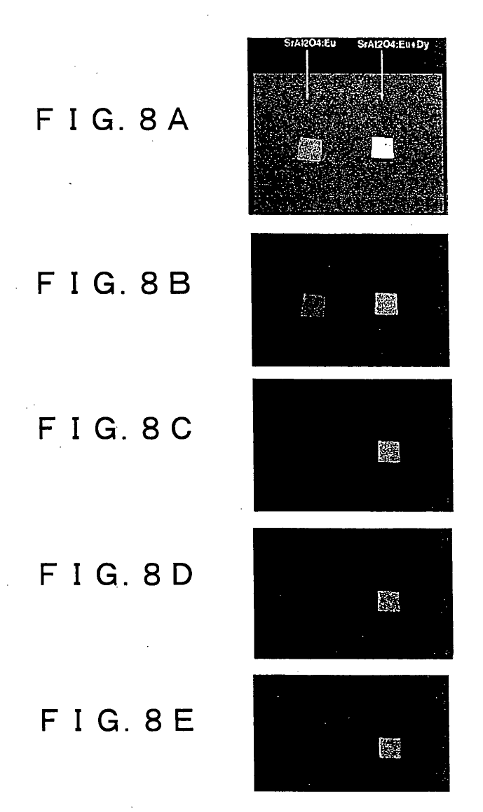

A very important experimental result of-comparing a mixture sheet developed by Nemoto & Co., Ltd. with the mixture sheet developed by the present inventor in terms of lasting luminescence characteristic in a dark environment will be described. The mixture sheet developed by Nemoto & Co., Ltd. is produced by mixing a powder of SrAl₂O₄ doped with two kinds of rare earth elements (SrAl₂O₄:Eu+Dy) with a resin at a mixing ratio of 1:2 (=powder:resin), whereas the mixture sheet developed by the present inventor is produced by mixing the SrAl₂O₄:Eu powder with a resin at a mixing ratio of 1:2 (=powder:resin). The comparison result is shown in FIGS. 8A to 8E.

In each of FIGS. 8A to 8E, the behavior of the inventive sheet (SrAl₂O₄:Eu) is shown on the left side and the behavior of the comparative sheet (SrAl₂O₄:Eu+Dy) is shown on the right side. Both the sheets are identical to each other in external appearance and color tone in a bright room; however, after the light in the room is turned off, the luminescence states of both the sheets become different from each other. More specifically, in the dark room, the luminescence emission of the inventive sheet (SrAl₂O₄:Eu) disappears to a large degree within one minute as viewed by the naked eye, whereas the luminescence emission of the comparative sheet (SrAl₂O₄:Eu+Dy) is kept for a long time. It is to be noted that the comparative sheet (SrAl₂O₄:Eu+Dy) has been developed as a sheet exhibiting a long-lasting luminescence characteristic.

In other words, the above result shows that the comparative sheet (SrAl₂O₄:Eu+Dy) is unsuitable for an artificial skin requiring stress luminescence. That is to say, since the comparative sheet exhibits the long-lasting luminescence characteristic by emitting luminescence absorbed in daylight or in a bright environment, such a sheet remains luminous in the dark room before stress is applied to the sheet, and therefore, it is impossible to increase the ratio between luminous intensities before and after stress is applied to the sheet.

Accordingly, it is proven that the inventive sheet (SrAl₂O₄:Eu) exhibiting no long-lasting luminescence characteristic is suitable for such an application, that is, the artificial skin requiring stress luminescence.

The results of evaluating the luminescence characteristics of the SrAl₂O₄:Eu powder produced by the present inventor and the SrAl₂O₄:Eu+Dy powder developed by Nemoto & Co., Ltd. will be described below.

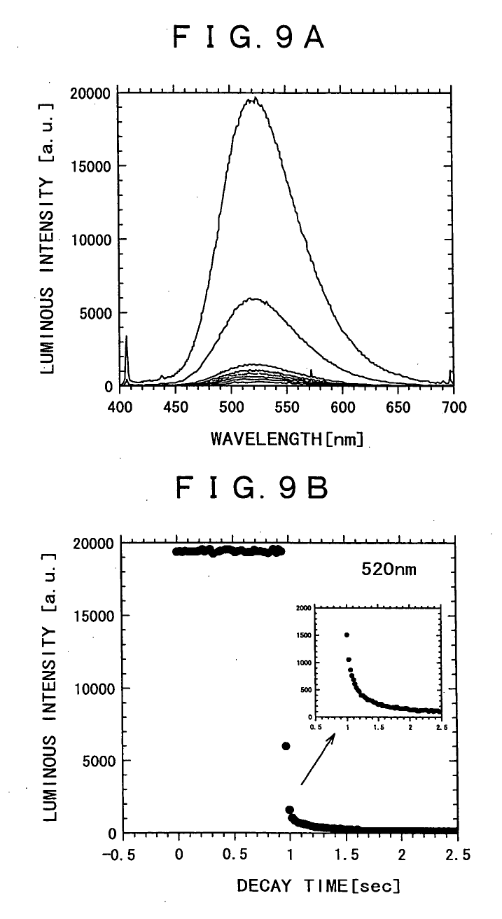

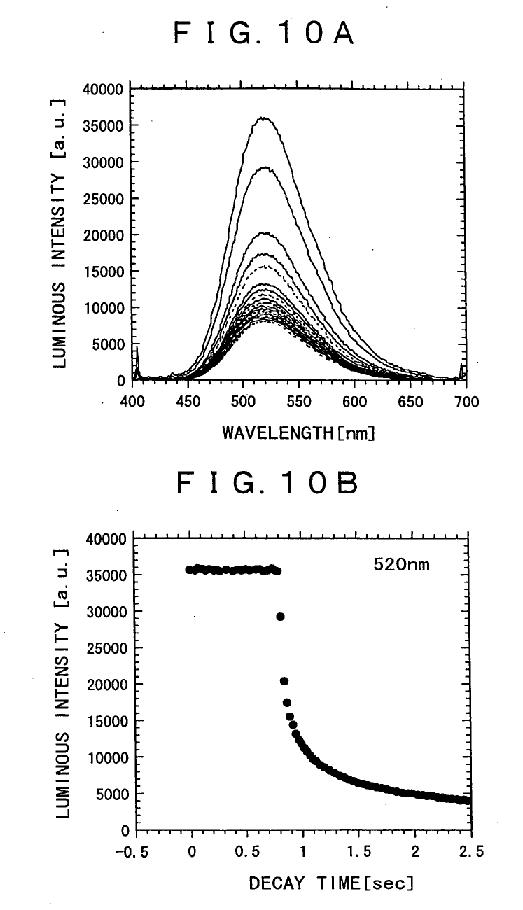

FIG. 9A shows an ultraviolet excited emission spectrum of the SrAl₂O₄:Eu powder produced by the present inventor and FIG. 9B shows a lasting luminescence characteristic thereof. FIG. 10A shows an ultraviolet excited emission spectrum of a SrAl₂O₄:Eu+Dy powder (commercially available from Nemoto & Co., Ltd. in the trade name of “LumiNova G-300C” and FIG. 10B shows a lasting luminescence characteristic thereof.

The SrAl₂O₄:Eu powder was produced by subjecting a raw mixture to calcination at 1400° C. for 2 hr in an oxygen atmosphere and reducing heat-treatment at 1300° C. for 2 hr in a N₂-4% H₂ atmosphere. In addition, it was previously confirmed that it is sufficient for calcination before reducing heat-treatment to be performed only once. A sample for measurement was thus produced. It was confirmed that the sample has a single phase. It is to be noted that the temperature of the reducing heat-treatment is not limited to 1300° C. but may be set in a range of at least 500° C. or more.

Each of the samples emits luminescence of green, and exhibits a main peak of emission at a wavelength near 520 nm. As a result of examining the lasting luminescence characteristic after stop of ultraviolet irradiation, the inventive sample SrAl₂O₄:Eu powder decays very earlier than the comparative sample (SrAl₂O₄:Eu+Dy) does. Since the emission spectrum in each FIG. 9A and 10A is plotted by overlapping results measured every 25 msec, it is possible to confirm that the intensity of the emission spectrum is gradually reduced.

The emission spectrum and the mechanism thereof will be described below.

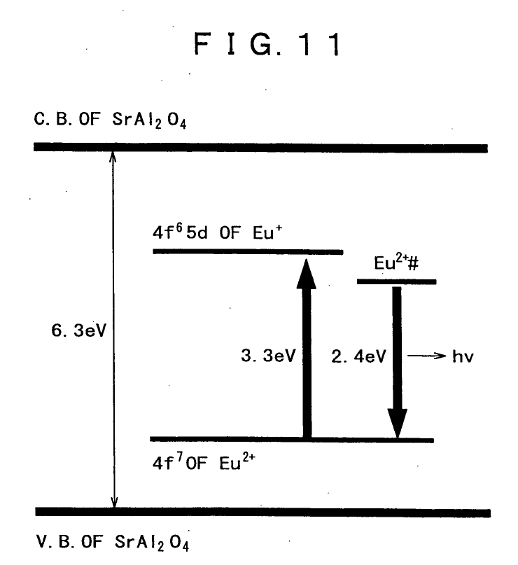

FIG. 11 is an energy band diagram showing luminescence emission of SrAl₂O₄:Eu. In this figure, V.B. denotes a valence band, and C.D. denotes a conduction band.

The emission mechanism has been somewhat revealed by study findings made by Matsuzawa and others (Nemoto & Co., Ltd.) and Jo and others (Kyushu National Industrial Research Institute), and by evaluation made by Hiroi and others (Niigata University). The emission spectrum may be examined basically on the basis of the understanding of photoluminescence because the wavelength of the stress luminescence is identical to the wavelength of ultraviolet excited photoluminescence. However, the change in energy due to stress should be separately examined. As shown in FIG. 11, in an energy transition step, there occurs so-called charge transition that Eu²⁺ (bivalent) incorporates an electron in the valence band to be thus converted into Eu⁺ (monovalent), with a result that a hole occurs in the valance band. The hole in the valence band is restricted by the Eu⁺ effectively charged with negative electricity in the excitation state, and Eu^{2+#} in a new excitation state is formed. As a result, light is emitted in the form of recombination of Eu^{2+#} with the hole. Luminescence emission of about 2.4 eV (520 nm) thus occurs by d→f transition.

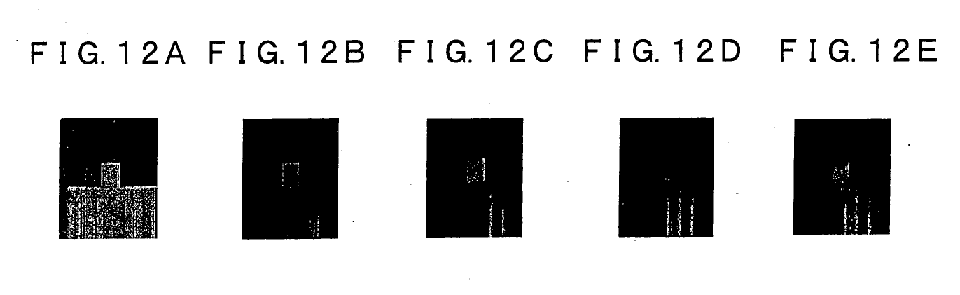

The luminescence emission phenomenon of the composite material of the SrAl₂O₄:Eu powder and a resin by applying stress thereto and releasing the stress is shown in FIGS. 12A to 12E.

FIGS. 12A to 12E are replicated time-elapse photographs, taken from recorded video, of the luminescence emission characteristic of the composite material by applying stress thereto and releasing the stress.

A sample of the composite material is placed on a press platen (see FIG. 12A). In a dark state before pressed, the sample has slight lasting luminescence (see FIG. 12B). At the moment of pressing, the sample emits intensive luminescence (see FIG. 12C). With the pressed state kept, luminescence disappears (see FIG. 12D). After that, the pressure is released (see FIG. 12E).

As is apparent from the above, the term “stress luminescence” used herein physically means luminescence caused by time-differential of stress. This is confirmed from the fact that the intensity of luminescence becomes large with the increased pressing rate.

On the basis of the above-described knowledge that the luminous intensity is greatly dependent on time-differential of stress or pressing rate, the present inventor has made an experiment for examining whether or not the composite material produced by the present inventor emits luminescence by applying ultrasonic vibration thereto.

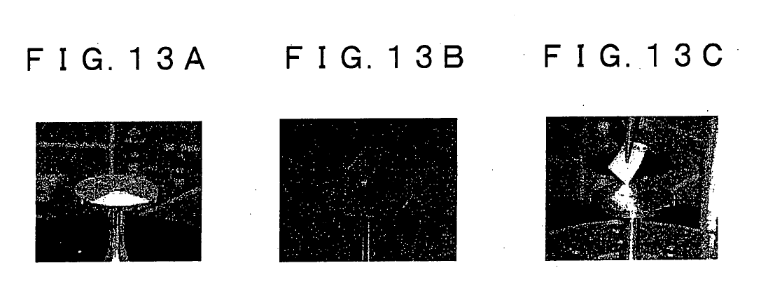

An ultrasonic transducer commercially available from Honda Electronics Co., Ltd. (resonance frequency: 39.30 kHz, resonance impedance: 180 Ω, electrostatic capacitance: 2480 pF) was used for the experiment. The ultrasonic transducer is of a type including a horn at an oscillation portion. The composite sheet of SrAl₂O₄:Eu and a polyester resin was brought into contact with the ultrasonic horn in the resonant state, as a result of which luminescence of the composite sheet was observed as expected. The result is shown in FIGS. 13A to 13C.

FIG. 13A is a photograph schematically showing the ultrasonic horn, FIG. 13B is a photograph showing the luminescence of the sheet in a dark field, and FIG. 13C is a replicated photograph taken from a video recorded using a night shot photographing function. From FIGS. 13B and 13C, it is apparent that the sheet emits luminescence when applied with ultrasonic waves. To be more specific, ultrasonic waves propagate in the composite sheet, to reach fine particles of SrAl₂O₄:Eu, whereby the fine particles emit luminescence. However, unless the sheet is brought into strong-contact with the ultrasonic horn stage, luminescence emitted from the sheet is weak. It may be considered that the sheet can be made to more efficiently emit luminescence by suppressing a propagation loss of the ultrasonic waves.

In addition, to confirm the effect of heat generation at the contact surface, the presence or absence of luminescence was examined by bringing the composite sheet with a heat-generation portion such as a hot plate, with a result that any visible luminescence was not observed at all by this experiment. This proves that the luminescence is clearly caused by ultrasonic vibration. This is envisaged from the research on thermo-luminescence made by Hiroi and others in Niigata University. It has been reported that the SrAl₂O₄:Eu powder exhibits a large peak of thermo-luminescence (associated with trap) at 230 K, and the intensity is reduced to at least ⅓. That is to say, it is apparent that even if the sheet is exposed to a temperature equal to or more than room temperature, the sheet emits less luminescence only by heat.

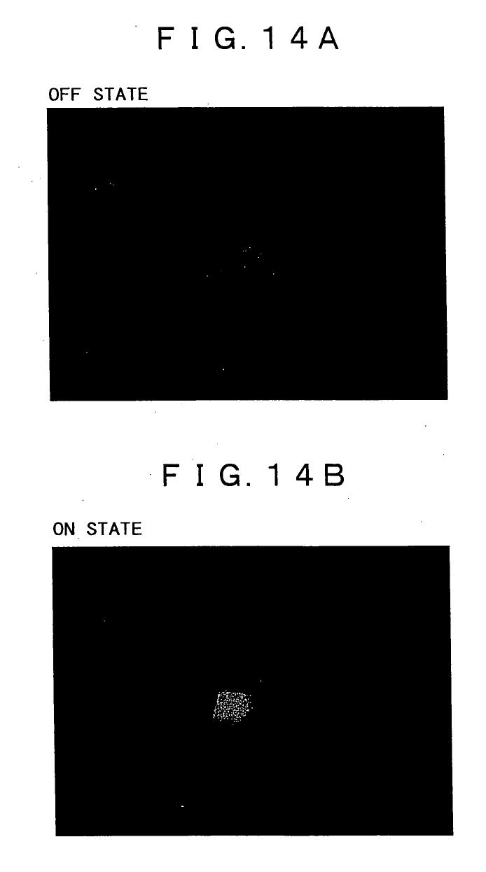

To increase the efficiency of luminescence due to ultrasonic waves, an experiment using a transducer operable at a higher frequency (MHz) was made. The transducer used in this experiment is of the same type as that used for ultrasonic humidifier or the like and has a disk-like shape having a diameter of about 2 cm and a thickness of 1 mm. The sheet was stuck on the transducer, and vibration at a frequency of 2.4 MHz was applied to the sheet as shown in FIGS. 14A and 14B. FIG. 14A shows the OFF state of the transducer and FIG. 14B shows the ON state of the transducer.

The mode of piezoelectric vibration is mainly set to longitudinal vibration in the thickness direction. As shown in FIG. 14B, luminescence having a clear, high intensity was observed. This may be due to the fact that acceleration becomes higher with higher frequency vibration.

From the results of such a basic experiment, it may be conceivable to allow the sheet to emit luminescence by using surface waves, and to allow a distant board composed of the stress-luminescent composite material to emit luminescence by irradiating the board with ultrasonic waves propagating in air. In this way, it is very valuable to directly convert a vibrational energy to an optical energy.

The technical characterization of the composite sheet produced by the present inventor is summarized as follows:

The property of the SrAl₂O₄:Eu material on thermo-luminescence has been known; however, the property of the SrAl₂O₄:Eu material on stress luminescence of the SrAl₂O₄:Eu material has been reported almost by a research group of Jo, Akiyama, and other others in Kyushu National Industrial Research Institute. Jo, Akiyama, and others have reported that not only a composite material containing the SrAl₂O₄:Eu material and a solid ceramic but also the composite material containing the SrAl₂O₄:Eu material and a resin (only epoxy resin) emits luminescence when hit or pressed; however, each of the composite materials has been formed into a bulk body. Any experiment report on luminescence emission of a composite material containing the SrAl₂O₄:Eu material by slight contact of a finger therewith or by directly applying ultraviolet vibration thereto has been unknown throughout the world.

The phenomenon that the composite sheet of the fluorescent SrAl₂O₄:Eu powder and a polyester resin emits luminescence by bringing the sheet into contact with an ultrasonic-vibrating object has been first observed by the present inventor. This means the possibility of controlling the luminescence of a solid not by a simple mechanical energy but by electrically controllable ultrasonic vibration. On the other hand, it was confirmed that the same sheet easily emits luminescence by simple bending. The characteristic of the sheet to emit luminescence by spontaneous bending and the characteristic of the sheet to emit luminescence by electrical control are very effective particularly in terms of application of the sheet to artificial skins.

In view of the foregoing, the present inventor proposes the following device.

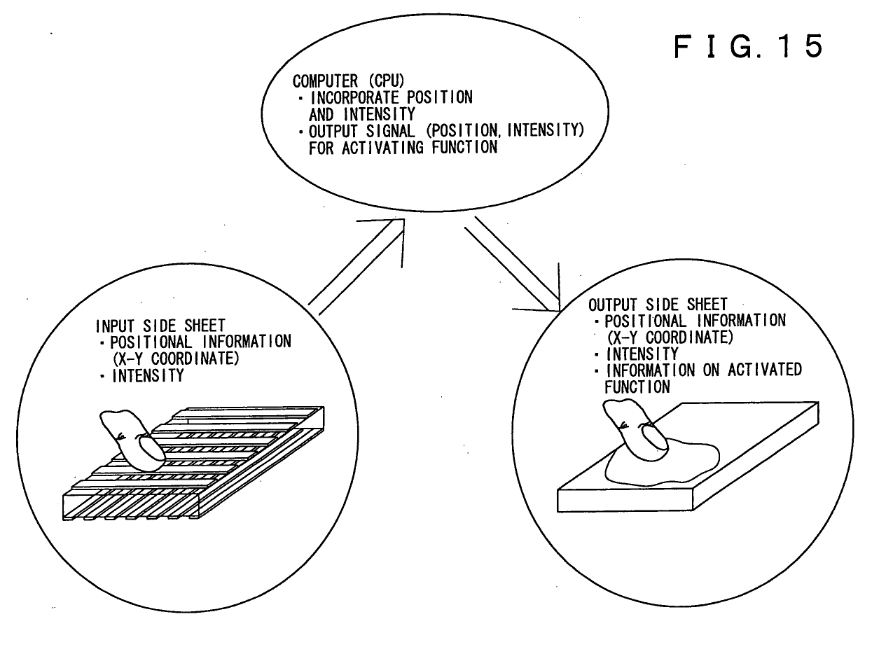

The composite sheet of the present invention can be applied to an artificial skin used for so-called entertainment robots or other industrial robots. The conceptual view of such an artificial skin including the composite sheet is shown in FIG. 15.

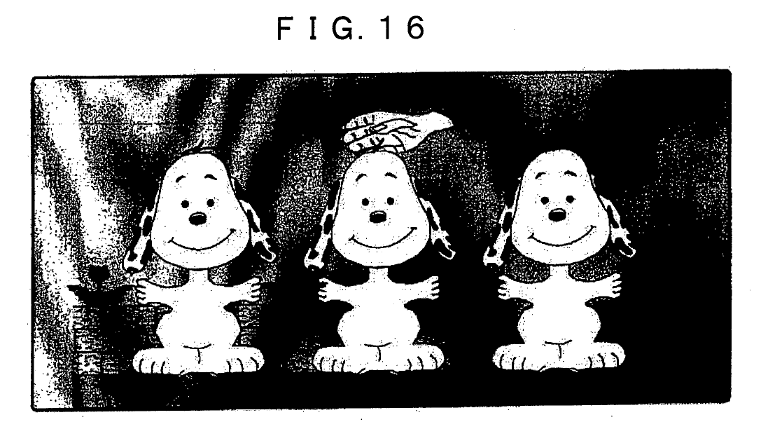

As is apparent from the figure, when a user touches an arbitrary location of the artificial skin, not only the location spontaneously emits luminescence, but also information on the position of the touched location and the luminous intensity is once stored in a CPU by means of another device and after a suitable time shift, a location at the specific position is made to emit luminescence. The image diagram of such luminescence after time shift is shown in FIG. 16. As shown in FIG. 16, the cheek of a dog whose head has been touched by a user with his or her hand is flushed after a slight elapse of time. Such luminescence after time shift can be easily realized by combination of the composite material and the system shown in FIG. 15.

Composing elements and the like of the artificial skin will be described below.

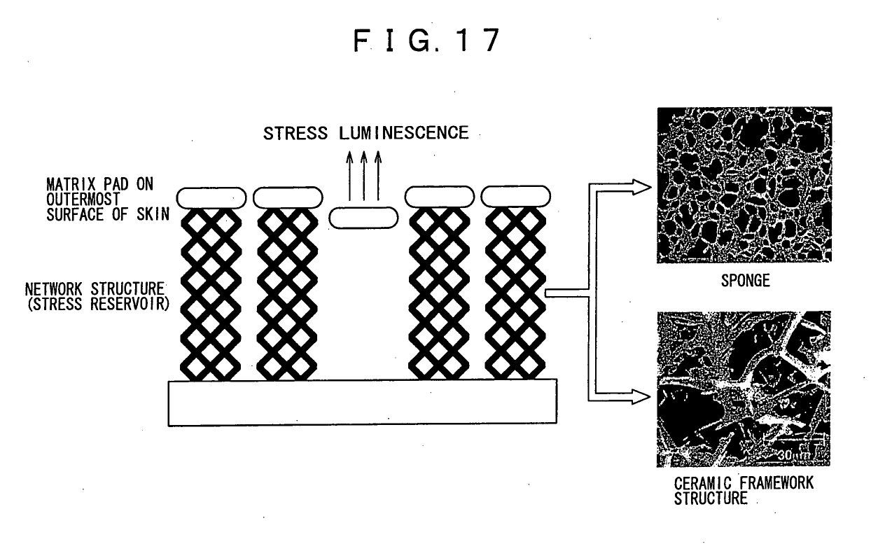

The artificial skin is required to have a certain level of flexibility. From this viewpoint, with respect to a stress-luminescent composite material containing the SrAl₂O₄:Eu ceramic used for the artificial skin, as described above, it may be conceivable to use an elastomer such as a resin as a matrix of the composite material or to sandwich the SrAl₂O₄:Eu ceramic between rubber materials. In addition to this, from the same viewpoint, it may be conceivable to make the SrAl₂O₄:Eu ceramic in the form of fiber shape, sponge shape, or framework shape in order to allow the SrAl₂O₄:Eu ceramic itself to have a certain level of flexibility. In the latter case, the single SrAl₂O₄:Eu ceramic, which is not mixed with any elastomer or rubber, is usable as the flexible stress-luminescent material suitable for the artificial skin. FIG. 17 is an image diagram showing an artificial skin using the sponge-shaped SrAl₂O₄:Eu ceramic and the framework-shaped SrAl₂O₄:Eu ceramic.

As shown in FIG. 17, when compressed by an external force, the framework structure of the artificial stress-luminescent skin emits luminescence. Although not only the framework structure of the SrAl₂O₄:Eu ceramic but also the sponge structure thereof is shown in FIG. 17, such a structure can be formed by a general method, for example, by forming a sintered body of the SrAl₂O₄:Eu ceramic, and removing grains with an acid or the like, thereby allowing only grain boundaries to remain. In the case of allowing the SrAl₂O₄:Eu ceramic to remain at the grain boundaries, there may be adopted a method of mixing the SrAl₂O₄:Eu ceramic with a material less reacting therewith, sintering the mixture, and removing the material with an acid or the like. One example of such a method, which is applied to a ZnO-Nb₂O₅ based ceramic material, has been described in a document (Kenya Hamano, Kensho Sayano, Zenbe Nakagawa, Journal of Ceramic Society of Japan, 91(1983) 309-317).

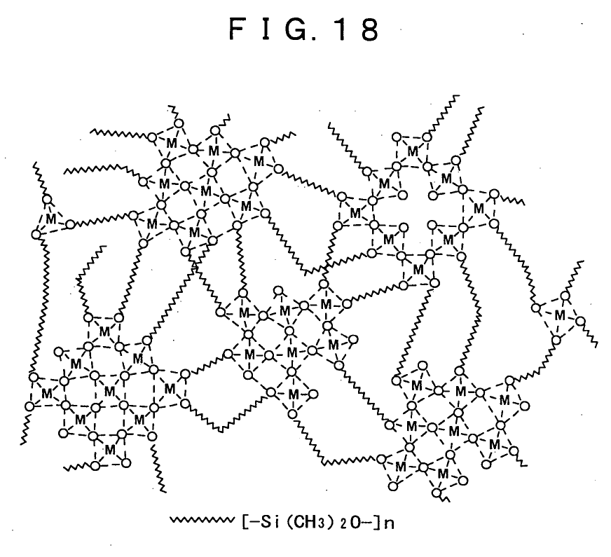

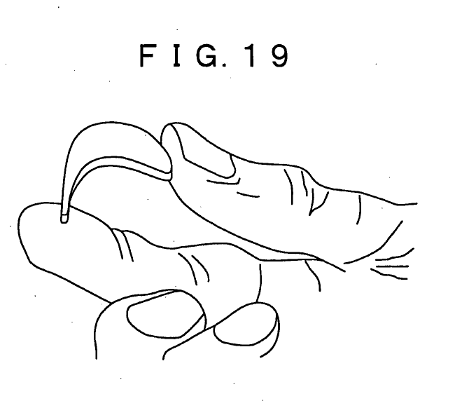

The above stress-luminescent composite material having a flexible structure is also exemplified by an inorganic/organic thybrid (nano) composite material. In this inorganic/organic hybrid composite material, preferably, the SrAl₂O₄:Eu portion is selectively present as in the form of nano-crystals. In this case, the matrix of the composite material is made from an inorganic/organic hybrid composite material. FIG. 18 is an image diagram of the inorganic/organic hybrid composite material. FIG. 19 is a view of the inorganic/organic hybrid composite material formed into a sheet, showing the state that the 'sheet is bent by a user with his or her fingertips.

In FIG. 18, wavy lines indicate siloxane bonds ( Si—O—Si—), wherein M-O bonds (M is herein represented by Sr or Al) are present at terminals of the siloxane bonds. In the case of the inorganic/organic hybrid composite material, when a mechanical displacement propagates to the siloxane bonds to reach the Sr—O bonds and Al—O bonds spatially dotted, the composite material emits luminescence.

The inorganic/organic hybrid composite material is produced by using, as a raw material, siloxane (having the siloxane bonds (—Si—O—Si—)), which is a product obtained as a result of hydrolysis of tetraethoxysilane (Si(OC₂H₅)₄, TEOS), and more simply produced by using, as a raw material, polydimethylsiloxane (HO—(Si(CH₃)₂)—OH, PDMS), and making the raw material reacting with aluminum alkoxide (for example, Al(—O—CH(CH₃)₂)₃) and strontium . alkoxide (for example, Sr(—O—CH(CH₃)₂)₃) for forming a luminescent portion. Under a suitable reaction condition, there occurs dehydration-condensation reaction, to obtain a desired hybrid structure. One example of such a method has been described in a document (Noriko Yamada, Ikuko Yosinaga, Singo Katayama, Material Integration, 12(1999)51-56).

As another idea, an organic conductive material such as polypyrrole capable of incorporating ions may be used as a matrix surrounding a stress-luminescent material, to form a composite material, wherein the organic conductive material is disposed oppositely to an external electrode. When the composite material is bent, not only the stress-luminescent material but also the organic conductive material is able to emit luminescence.

Next, there will be described a configuration in which the above-described stress-luminescent material is used as a material for allowing a two-dimensional surface to emit luminescence. Unlike a semiconductor laser, a light emitting diode, and the like, such a configuration does not require injection of a current, and therefore, is advantageous in realizing energy-saving.

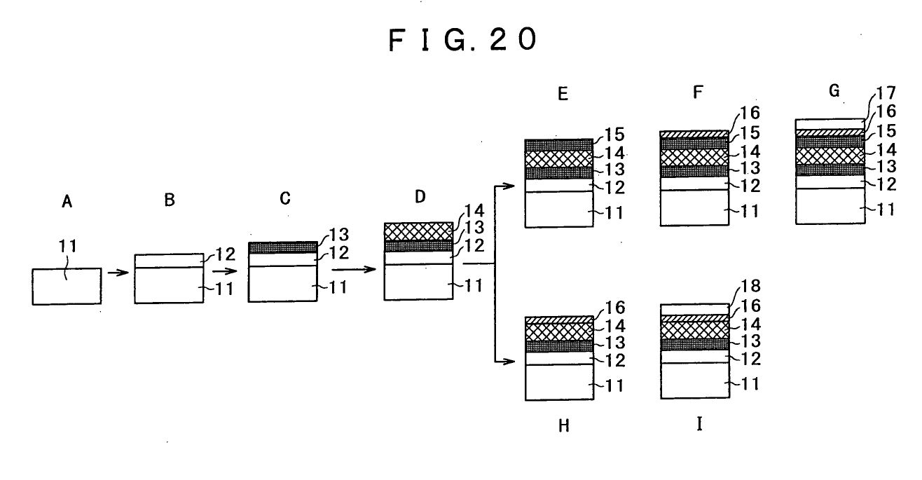

The above-described configuration is exemplified by a light emitting device produced by stacking a piezoelectric thin film made from PZT or the like on a Si substrate and stacking a stress-luminescent material on the piezoelectric thin film. FIG. 20 shows two methods of fabricating two kinds of light emitting devices each of which is a composite material of the stress-luminescent material and the piezoelectric material.

In steps (A) and (B) shown in FIG. 20, a CeO₂ film having the (001) orientation is epitaxially grown as a buffer layer 12 on a Si substrate 11 having the (001) orientation. In step (C) shown in FIG. 20, a perovskite type conductive thin film such as a SrRuO₃ thin film having the (001) orientation is epitaxially grown as a lower electrode layer 13 on the buffer layer 12. In step (D) shown in FIG. 20, a perovskite type thin film such as a PZT film having the (001) orientation is epitaxially grown as a piezoelectric thin film 14 on the lower electrode layer 13.

After the step (D), the process differs depending on the type of the light emitting device.

In the case of producing one type of the light emitting device, a perovskite type conductive thin film such as a SrRuO₃ thin film having the (001) orientation is epitaxially grown as an upper electrode layer 15 on the piezoelectric thin film 14 in step (E) shown in FIG. 20; a SrAl₂O₄:Eu ceramic or a composite material of the SrAl₂O₄:Eu ceramic and a resin or the like is stacked as a stress-luminescent layer 16 on the upper electrode layer 15 in step (F) shown in FIG. 20; and a thin film made from glass, transparent organic resin, or the like is formed as a transparent cap layer 17 on the stress-luminescent material 16 in step (G) shown in FIG. 20. In the light emitting device thus produced, a piezoelectric longitudinal vibration, which occurs in the piezoelectric thin film 14 by applying a voltage between the lower electrode layer 13 and the upper electrode layer 15, desirably propagates to the stress-luminescent layer 16, to cause the stress-luminescent layer 16 to efficiently emit luminescence.

In the case of producing another type of the light emitting device, the stress-luminescent layer 16 is directly stacked on the piezoelectric thin film 14 in step (H) shown in FIG. 20; and a transparent conductive film made from ITO, CuAlO₂, or the like is stacked as an upper transparent electrode layer 18 in step (I) shown in FIG. 20. In the light emitting device thus produced, a piezoelectric longitudinal vibration, which occurs in the piezoelectric thin film 14 by applying a voltage between the lower electrode layer 13 and the upper transparent electrode layer 18, desirably propagates to the stress-luminescent layer 16, to cause the stress-luminescent layer 16 to efficiently emit luminescence

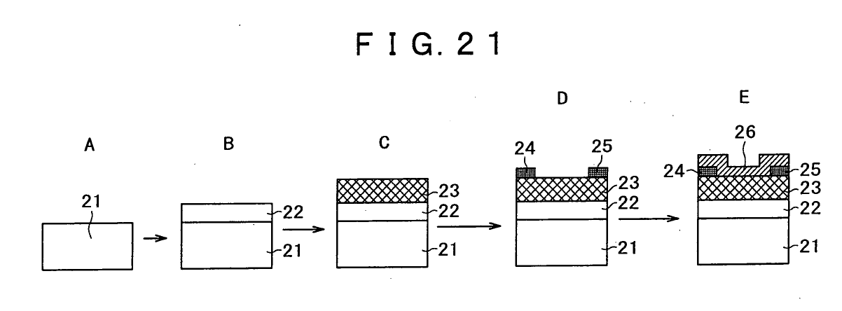

Although each of the above-described two types of light emitting devices makes use of so-called piezoelectric vibration, a light emitting device making use of surface acoustic waves is also useful. FIG. 21 shows a method of producing such a light emitting device making use of surface acoustic waves.

In steps (A) and (B) shown in FIG. 21, a CeO₂ film having the (001) orientation is epitaxially grown as a buffer layer 22 on a Si substrate 21 having the (001) orientation. In step (C) shown in FIG. 21, a perovskite type thin film such as a PZT film having the (001) orientation is epitaxially grown as a piezoelectric thin film 23 on the buffer layer 22. In step (D) shown in FIG. 21, a perovskite type conductive thin film such as a SrRuO₃ thin film having the (001) orientation is epitaxially grown on the piezoelectric thin film 23, followed by patterning, to form two comb-shaped electrodes 24 and 25 which are opposed to each other. In step (E) shown in FIG. 21, a SrAl₂O₄:Eu ceramic or a composite material of the SrAl₂O₄:Eu ceramic and a resin or the like is stacked as a stress-luminescent layer 26 between the comb-shaped electrodes 24 and 25. In the light emitting device thus produced, surface acoustic waves, which occur in the piezoelectric thin film 23 by applying a voltage between the comb-shaped electrodes 24 and 25, desirably propagates to the stress-luminescent layer 26, to cause the stress-luminescent layer 26 to efficiently emit luminescence.

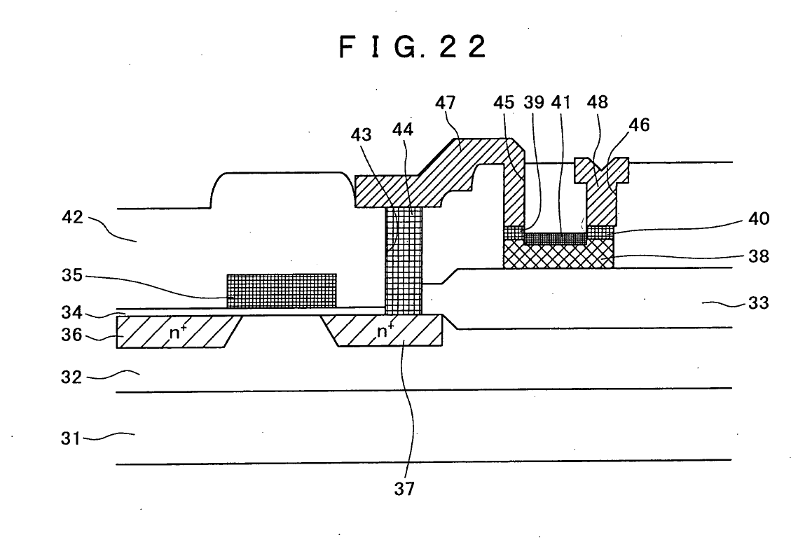

An example in which the above-described light emitting device is integrated with a MOSFET will be described below. FIG. 22 shows a light emitting device in which the above-described surface acoustic wave type light emitting device.

As shown in FIG. 22, a p-well 32 is formed on an n-type Si substrate 31, and a CeO₂ film having the (001) orientation is formed as a field insulating film 33 for device isolation on the surface of the p-well 32. A gate insulating film 34 made from SiO₂ is formed on the surface of an active region surrounded by the field insulating film 33, and a gate electrode 35 made from poly-Si doped with an impurity or a polycide is formed on the gate insulating film 34. An N⁺-type source region 36 and a drain region 37 are formed in the p-well 32 in such a manner as to be in self-alignment with the gate electrode 35. The gate electrode 35, the source region 36, and the drain region 37 form an n-channel MOSFET.

On the other hand, a perovskite type thin film such as a PZT film having the (001) orientation is stacked as a piezoelectric thin film 38 on the field insulating film 33, and a perovskite type conductive thin film such as a SrRuO₃ thin film having the (001) orientation is formed on the piezoelectric thin film 38, followed by patterning, to form two comb-shaped electrodes 39 and 40 opposed to each other. A SrAl₂O₄:Eu ceramic or a composite material of the SrAl₂O₄:Eu ceramic and a resin or the like is stacked as a stress-luminescent layer 41 between the comb-shaped electrodes 39 and 40. The piezoelectric thin film 38, the comb-shaped electrodes 39 and 40, and the stress-luminescent layer 41 form a surface acoustic wave type light emitting cell.

An interlayer insulating film 42 such as a SiO₂ film is formed so as to cover the MOSFET and the light emitting cell. A connection hole 43 is formed in both the gate insulating film 34.and the interlayer insulating film 42 in such a manner as to be located at a position over the drain region 37. The connection hole 43 is buried with a plug 44 such as a poly-Si doped with an impurity or W. Connection holes 45 and 46 are formed in the interlayer insulating film 42 in such a manner as to be located at positions over the comb-shaped electrodes 39 and 40. The plug 44 is connected to the comb-shaped electrode 39 via the connection hole 45 by means of metal wiring 47, and metal wiring 48 is connected to the comb-shaped electrode 40 via the connection hole 46.

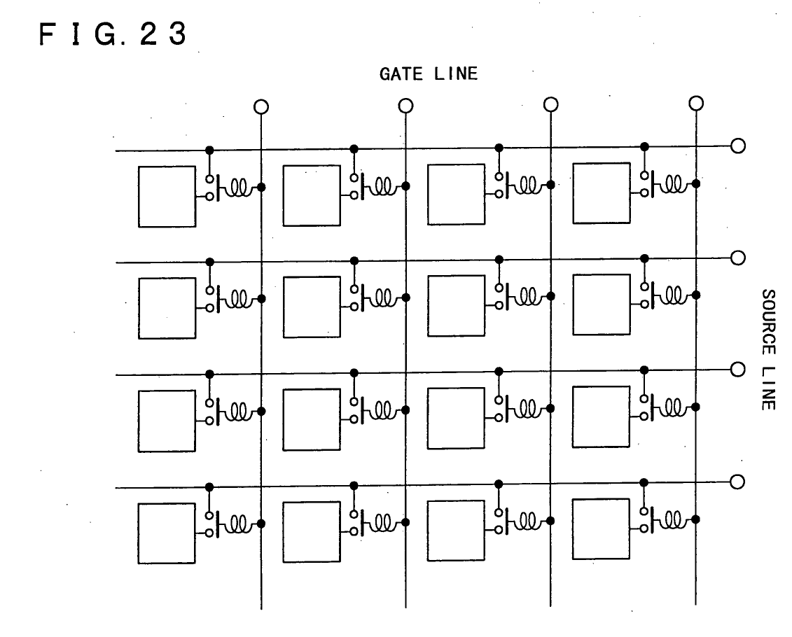

In the MOSFET integrated light emitting device configured as described above since the drain region 37 of the MOSFET is connected to one comb-shaped electrode 39 provided on the piezoelectric thin film 38 for creating surface acoustic waves, luminescence from the light emitting cell can be controlled by switching the MOSFET. In other words, the MOSFET integrated light emitting device can be driven under an active matrix drive mode. Accordingly, the MOSFET integrated light emitting device can be driven by using am active matrix circuit shown in FIG. 23. In the figure, symbol 1 indicates a light emitting cell. A source line is connected to the source region 36 of the MOSFET of each pixel portion, and a gate line is connected to a gate electrode 35 of the MOSFET of each pixel portion.

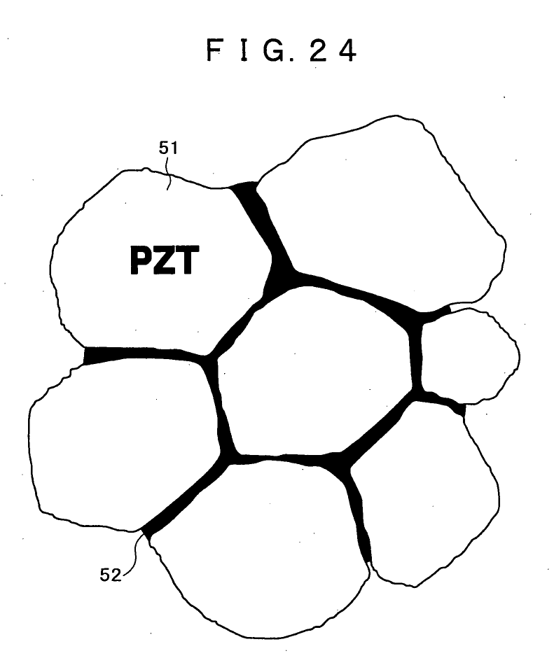

A light emitting device using a ceramic mixture will be described below. One example of such a light emitting device is shown in FIG. 24. The device uses a ceramic mixture of a stress-luminescent material and a piezoelectric material. To be more specific, fine crystals of a piezoelectric ceramic, for example, fine crystals 51 of PZT are used as grains, and a stress-luminescent material, for example, a SrAl₂O₄:Eu ceramic 52 is used as a matrix (forming grain boundaries).

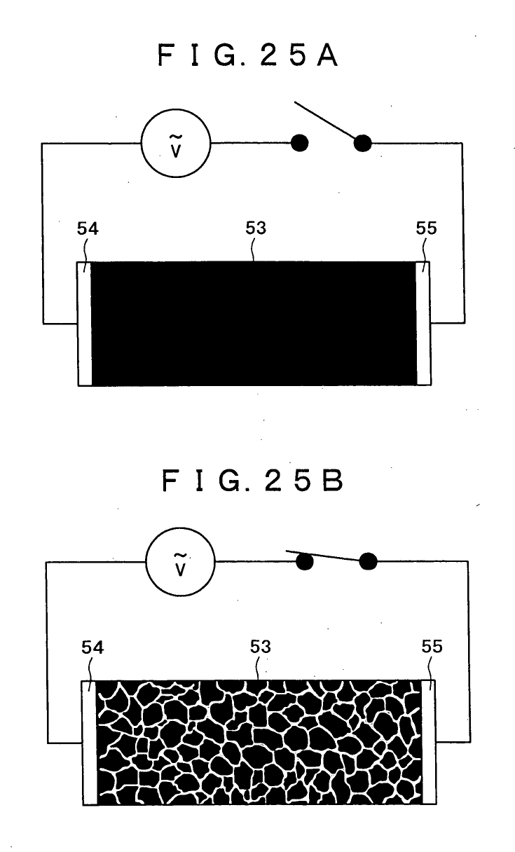

As shown in FIG. 25A, electrodes 54 and 55 are provided in such a manner as to sandwich a ceramic material 53 having such a fine structure therebetween, and as shown in FIG. 25B, an alternating electric field is applied between the electrodes 54 and 55 from external, to cause piezoelectric vibration, thereby allowing the grain boundaries of the ceramic material 53 to emit luminescence.

A method of producing the ceramic mixture will be described below. Like the above-described method of producing the SrAl₂O₄:Eu ceramic, raw materials SrCO₃, Al₂O₃, Eu₂O₃, and B₂O₃ were mixed at a specific mixing ratio in a ball mill. The mixture was melted by a heat-treatment, and was rapidly cooled from the melted state once, to form a glass phase. The glass phase was pulverized, and the resultant powder was mixed with fine crystals of PZT, followed by a heat-treatment, to precipitate SrAl₂O₄:Eu at grain boundaries of the fine crystals of PZT from the glass phase.

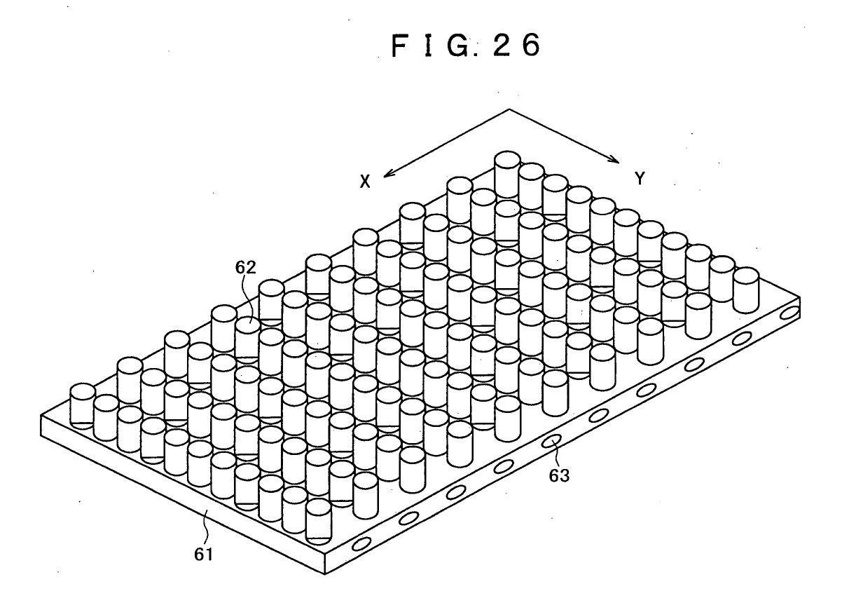

One example of a method of fabricating a light emitting device using an actuator substrate will be described below. As shown in FIG. 26, stress-luminescent dots 62 are formed on an actuator substrate 61 in such a manner as to be arranged periodically in the X-direction and the Y-direction by injecting stress-luminescent ink (or paint) containing a stress-luminescent material such as a SrAl₂O₄:Eu ceramic on the actuator substrate 61 by an ink-jet manner.

The actuator substrate 61 is formed of a polymer gel device, a piezoelectric device, an ultrasonic device, a super-magnetostriction device, a shape memory alloy device, a hydrogen storage device, a heat-generation device (for example, bimetal), or the like. The polymer gel device is represented by a water-soluble non-electrolytic polymer gel displaceable with the change in heat, particularly, a water-soluble non-electrolytic polymer gel having ether groups at side chains, for example, polyvinyl methyl ether (PVME) or poly n-isopropyl acrylamide (PNIPAM). A combination of an electrolytic polymer gel displaceable with the change in pH such as polyacrylonitrile (PAN) or polyacrylamide-2-methyl-propanesulfonic acid (PAMPS) displaceable with the change in electricity with:a surface-active agent, or polyvinyl alcohol may be used as the polymer gel device. Further, polypyrrole is used as an organic molecular actuator.

Surface acoustic waves, piezoelectric longitudinal vibration, or mechanical surface wrinkles may be used as a drive mode of the acutuator substrate 61. To cause a change in surface state with elapsed time, the above-described actuator material may be periodically inserted in the actuator substrate 61. FIG. 26 shows an example in which actuator material members 63 are inserted in the actuator substrate 61 along the Y-direction in such a manner as to be periodically arranged in the X-direction. In this example, the surface state of the actuator substrate 61 can be periodically displaced by periodically inserting the actuator material members 63 in the actuator substrate 61.

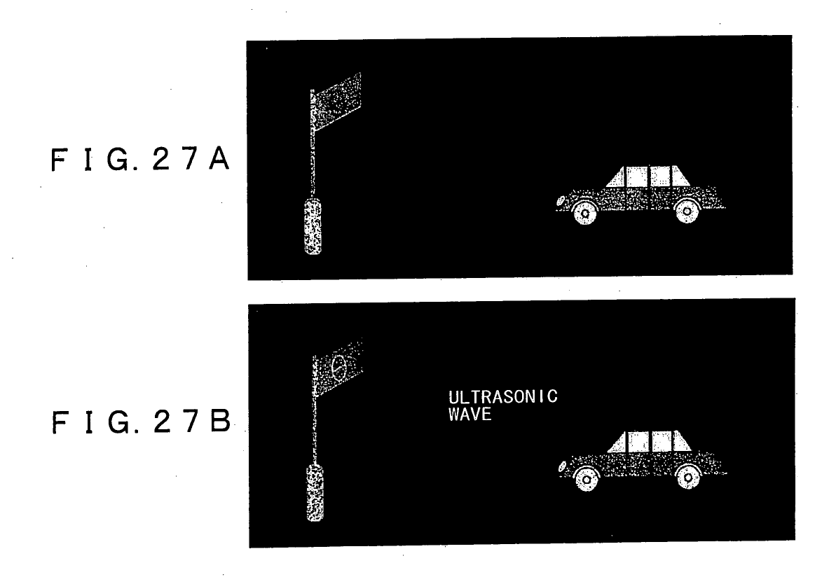

A road sign light emitting system making use of ultrasonic waves will be described below. FIGS. 27A and 27B show one example of such a road sign light emitting system. In this road sign light emitting system as shown in FIG. 27A, a necessary mark is formed on the surface of a sign portion by using the stress-luminescent material of the present invention or a composite material containing the stress-luminescent material, and an ultrasonic vibrator is mounted on an automobile. As shown in FIG. 27B, when ultrasonic waves generated by the ultrasonic vibrator mounted on an automobile reach the sign portion, the sign portion emits stress-luminescence, to allow a driver on the automobile to perceive the emerged mark.

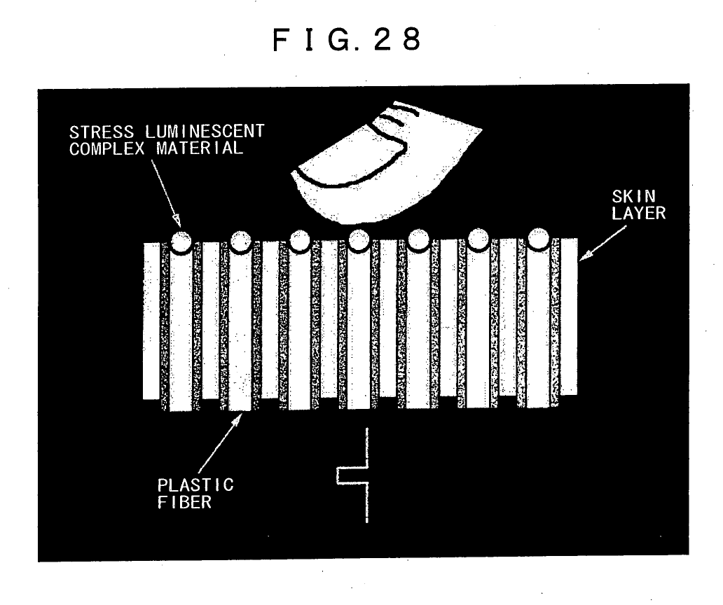

An artificial skin having an optical nerve network will be described below. FIG. 28 shows one example of such an artificial skin. As shown in FIG. 28, plastic fibers are provided in a two-dimensional array in such a manner as to pass through a skin layer made from an artificial skin material, and spherical stress-luminescent material is mounted to one end of each of the plastic fibers on the front surface side of the skin layer. The stress-luminescent material is exemplified by a composite material of a SrAl₂O₄:Eu ceramic and a polyester resin. In this artificial skin, when a finger of a user is touched on the surface of the artificial skin, luminescence occurring from the stress-luminescent composite material at the contact point passes trough the plastic fiber, to pulsedly emerge from the other end of the plastic fiber on the back surface side of the skin layer. Accordingly, the contact of the finger with the surface of the skin layer and the contact point can be detected from the emergence from the back surface side of the skin layer and the emergence position. This means that an optical nerve network is formed on the artificial skin.

An input apparatus according to a first embodiment of the present invention will be described below.

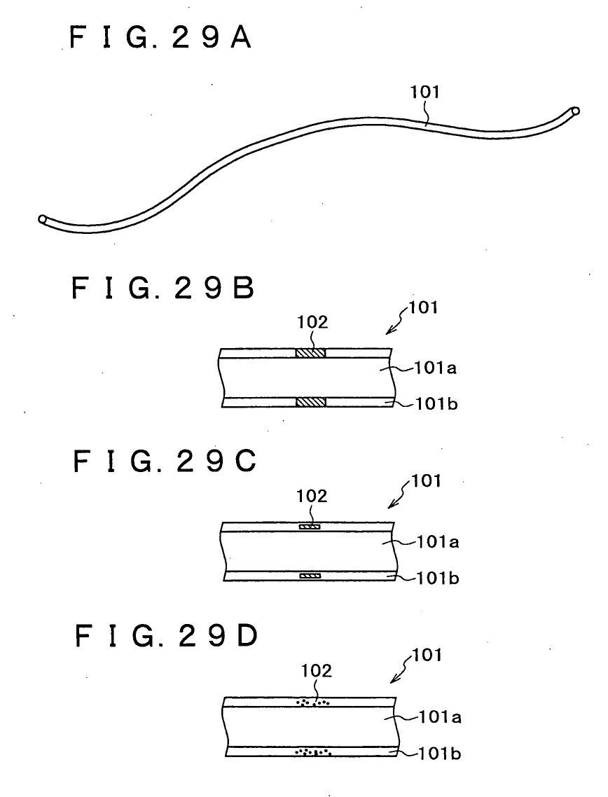

An optical fiber 101 shown in FIG. 29A is used as the input apparatus. The optical fiber 101 is formed into a rectangular shape in cross-section, although it may be formed into a circular shape in cross-section. The optical fiber 101 has a core disposed at a central portion and a clad disposed around the core. A stress-luminescent material is partially provided in the clad in such a manner as to extend in the longitudinal direction of the optical fiber 101. Examples of cross-sectional shapes of the optical fiber 101 including the stress-luminescent material are shown in FIGS. 29B to 29D.

In FIGS. 29B to 29D, reference numeral 10la denotes the core, and reference numeral 101b denotes the clad. In the example shown in FIG. 29B, the clad 101a of the optical fiber 101 is partially removed, and the stress-luminescent material 102 is provided in the removed portion. In the example shown in FIG. 29C, the stress-luminescent material 102, which is denoted by reference numeral 102, is buried in the clad 10la of the optical fiber 101. In the example shown in FIG. 29D, the stress-luminescent material 102 in the form of fine particles is buried in the clad 10la of the optical fiber 101. In each of these examples, the stress-luminescent material 102 may be provided on at an intersection portion where the optical fiber 101 crosses another optical fiber 101 or may be provided so as to extend around the entire periphery of the optical fiber 101.

The above-described composite material of the SrAl₂O₄:Eu powder and a polyester resin is preferably used as the stress-luminescent material 102. According to the present invention, however, any other stress-luminescent composite material may be used as the stress-luminescent material 102.

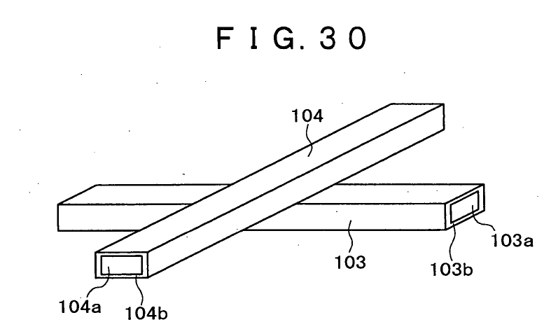

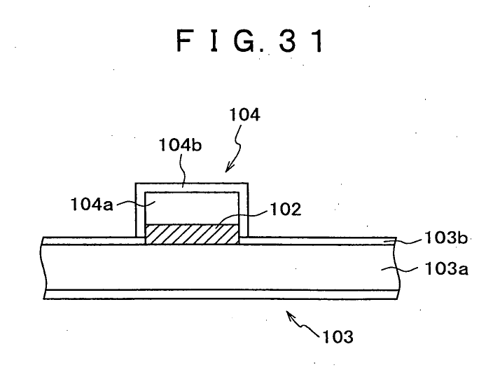

FIG. 30 shows the input apparatus according to the first embodiment, and FIG. 31 shows the cross-section of an intersection portion between optical fibers used for the input apparatus.

As shown in FIGS. 30 and 31, the input apparatus includes two optical fibers 103 and 104 disposed so as to intersect each other. The optical fiber 103 includes a core 103a and a clad 103b, and the optical fiber 104 includes a core 104a and a clad 104b. The optical fibers 103 and 104 are connected to each other via a stress-luminescent material 102 at the intersection portion. The stress-luminescent material 102 is exemplified by the composite material of the SrAl₂O₄:Eu powder and polyester.

In the input apparatus, as shown in FIG. 32, when the intersection portion between the optical fibers 103 and 104 is depressed by a finger 105, stress is concentrated at the stress-luminescent material 102, to cause the stress-luminescent material 102 to emit luminescence. The luminescence enters in the cores 103a and 104a of the optical fibers 103 and 104, being guided in the cores 103a and 104a, and emerges as light 106 from end faces of the cores 103a and 104a. The light 106 may be used as an output signal. Alternatively, if a light receiving device is directly-or indirectly connected to one end of each of the optical fibers 103 and 104, the light 106 can be received by the light receiving device, to be used as an output signal converted into an electric signal.

The stress-luminescent material 102 isotropically emits luminescence. Accordingly, the interface between the stress-luminescent material 102 and each of the optical fibers 103 and 104 may be formed into an irregular plane having projections and recesses. This is advantageous in enhancing the guidance efficiency of light in each of the cores 103a and 104a of the optical fibers 103 and 104. In this case, it is more preferred to set the degree of irregularities of the interface between the stress-luminescent material 102 and each of the optical fibers 103 and 104 within a range satisfying total-reflection of light by optimizing the tilt angles of the irregularities (projections and recesses) of the interface.

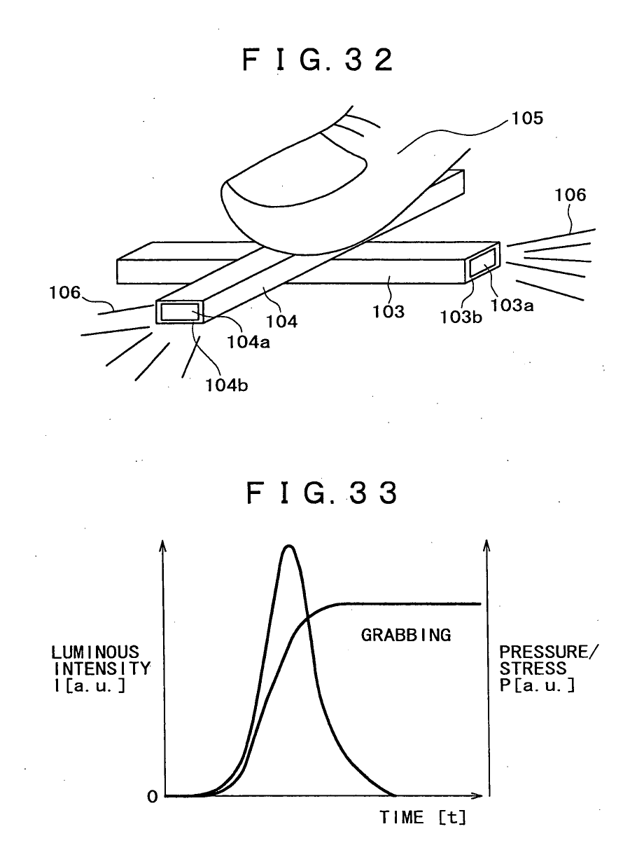

FIG. 33 shows a stress (P) applied to the stress-luminescent material 102 and a luminous intensity (I) as a function of time (t). As shown in this figure, when stress applied to a stress-luminescent material is changed, for example, by grabbing, the luminescence from the stress-luminescent material becomes very large to such a degree as to be visible.

The luminous intensity (I) is schematically expressed by CX (dP/dt), where C is a constant. This means that the input apparatus including the stress-luminescent material 102 performs a time-differential of a stress applied to the stress-luminescent material 102 or performs detection of a difference in stress applied to the stress-luminescent material 102. Also since the luminous intensity of the stress-luminescent material 102 has a positive correlation with the magnitude of a change in stress applied to the stress-luminescent material 102, the input apparatus can obtain information on the magnitude of stress 102.

According to the first embodiment, when a finger is touched to an intersection portion between the optical fibers 103 and 104, the light 106 can be taken out of the end face of each of the optical fibers 103 and 104. As a result, the input apparatus can detect the contact of the finger with the intersection portion between the optical fibers 103 and 104. In particular, if the input apparatus has pluralities of the optical fibers 103 and 104 disposed so as to intersect each other, such an input apparatus can accurately detect a contact position of a finger with the input apparatus.

The first embodiment has further advantages. The input apparatus uses the stress-luminescent material 102 as a light source. In other words, the input apparatus does not use, as the light source, any semiconductor laser or light emitting diode generally provided at the end face of each of the optical fibers 103 and 104. As a result, such an input apparatus is operable with no power consumption excluding power consumption for light receiving devices, to thereby significantly reduce power consumption as a whole. Also, since it is not required to dispose any light source at the end face of each of the optical fibers 103 and 104, the light receiving device can be disposed at the end face of each of the optical fibers 103 and 104. Further, since it is not required to dispose a fragile detector such as the light receiving device at an intersection portion between the optical fibers 103 and 104, it is possible to realize an extreme rigid input apparatus. In addition, since it is not required to dispose any wiring such as a lead wire for causing luminescence, it is possible to simplify the configuration of the input apparatus.

The input apparatus according to the first embodiment is particularly suitable as an optical tactile sensor.

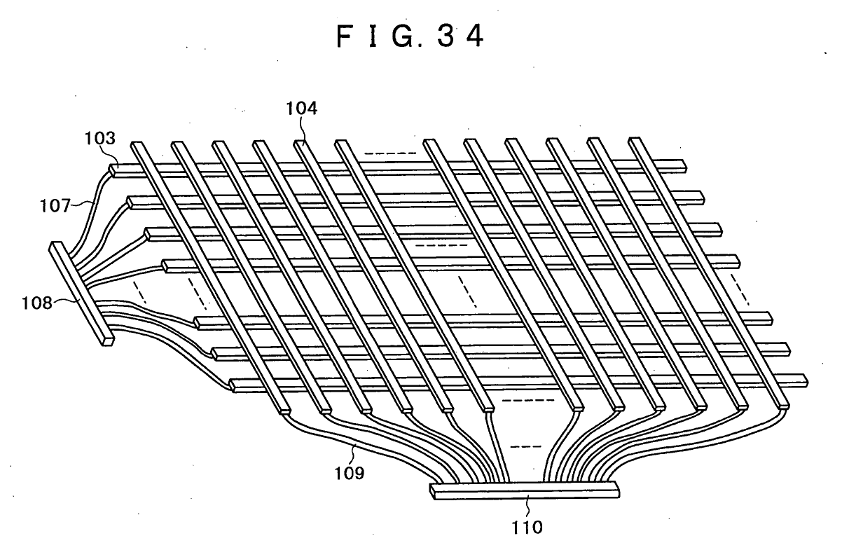

FIG. 34 shows a key input apparatus according to a second embodiment of the present invention.

As shown in FIG. 34, the key input apparatus includes optical fibers 103 of the number of M (M: an integer larger than 2) extending in the x-direction and optical fibers 104 of the number of N (N: an integer larger than 2) extending in the y-direction, wherein the optical fibers 103 and the optical fibers 104 intersect each other:. In this key input apparatus, each of intersection portions between the optical fibers 103 of the number of M and the optical fibers 104 of the number of N is taken as a key-position. The number of M of the optical fibers 103 and the number of N of the optical fibers 104 are determined depending on the number of keys and arrangement of the keys. As one example, the number of M is set to 6, and the number of N is set to 20. One end of each of the optical fibers 103 is connected to a line optical sensor 108 via the corresponding connecting optical fiber 107. Similarly, one end of each of the optical fibers 104 is connected to a line optical sensor 110 via the corresponding optical fiber 109. The line optical sensors 108 and 110 may be each represented by a CCD (Charge Coupled Device). While not shown, a cover made from a resin or the like and printed with characters or symbols indicating keys is provided on the surfaces of the optical fibers 103 and 104.

The other configurations of this embodiment are the same as those of the first embodiment, and therefore, overlapped description thereof is omitted.

According to the second embodiment, it is possible to realize a sheet-like super thin type key-input apparatus which is flexible, very easy in enlargement, and low in power consumption. Another advantage of this embodiment is that since the key input apparatus can detect a depressing force of a finger to a key for input, it is possible to realize such a high function as to shift a character corresponding to the key to a capital when the key is forcibly depressed, and hence to eliminate the need of provision of a shift key.

The key input apparatus is usable for various kinds of electronic equipment, particularly, preferably usable as an input apparatus of a so-called electronic paper type computer.

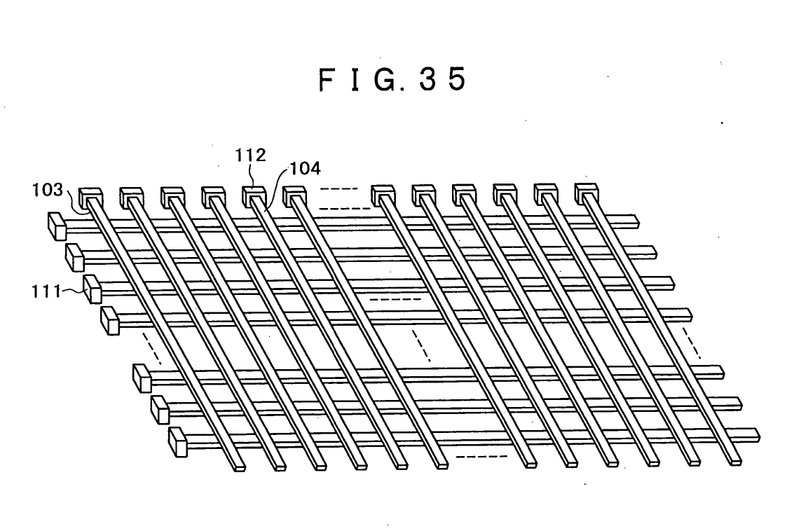

FIG. 35 shows a key input apparatus according to a third embodiment of the present invention.

As shown in this figure, the key input apparatus includes a plurality of optical fibers 103 and a plurality of optical fibers 104, wherein a light receiving device 111 is connected to one end of each of the optical fibers 103 and a light receiving device 112 is -connected to one end of each of the optical fibers 104.

The other configurations of this embodiment are the same as those described in the first and second embodiments, and the overlapped description is omitted.

According to the third embodiment, the same advantages as those of the second embodiment can be obtained.

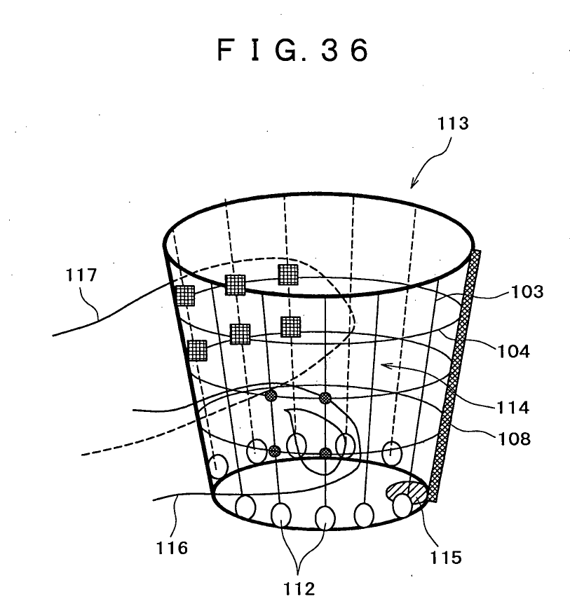

FIG. 36 shows an optical fiber sheet according to a fourth embodiment of the present invention.

An optical fiber sheet 114 according to this embodiment includes the same optical fiber array as that used in the second or third embodiment, wherein the optical fiber array is sandwiched between protective sheets made from, for example, a resin. As shown in FIG. 36, the optical fiber sheet 114 is wound around the side surface of a cup 113. One end of each of optical fibers 103 of the optical fiber sheet 114 is connected to a light receiving device 112, and one end of each of optical fibers 104 of the optical fiber sheet 114 is connected to a line optical sensor 108. Outputs from the light receiving devices 112 and the line optical sensor 108 are fed to an integrated communication module 115 provided on the bottom surface of the cup 113. The integrated communication module 115 includes a photoelectric transfer device, an oscillating device, and antenna, and is adapted to transmit information on light generated at intersection portions between the optical fibers 103 and 104 to external equipment.

According to the fourth embodiment, as shown in FIG. 36, when a user grabs the side surface of the cup 113 with a hand, a thumb 116 and another finger 117 of the hand are touched to the optical fiber sheet 114 wound around the cup 113, so that a pressure is applied to each of the portions, grabbed by the thumb 116 and another finger 117, of the optical fiber sheet 114. Consequently, at each intersection portion between the optical fibers 103 and 104 in the grabbed portion applied with the pressure, the stress-luminescent material 102 emits luminescence, and the position of the intersection portion is detected by the light receiving devices 112, the line optical sensor 108, and the integrated communication module 115.

In the example shown in FIG. 36, the luminescence points under the thumb 116 are four points close to each other and the luminescence points under another finger 117 are six points close to each other, and therefore, the number of groups (or set) of the luminescence points is two. Accordingly, on the basis of the signals fed from the integrated communication module 115, it can be recognized that the user grabs the cup 113 in a state that the thumb 116 and another finger 117 are located in such a manner as to be opposed to each other and to press the side surface of the cup 113.

It is assumed that the cup 113 is placed on a desk on which an optical fiber sheet is previously stuck. In this case, the cup 113 is recognized as a partial system on the desk. To be more specific, when the bottom surface of the cup 113 comes into contact with the desk, at each of optical fiber intersection portions in the contact portion, the stress-luminescent material 12 in the optical fiber sheet stuck on the desk emits luminescence by the effect of an acting force from the cup 113, and at the same time, the stress-luminescent material 12 in an optical fiber sheet stuck on the bottom surface of the cup 113 emits luminescence by the effect of a reaction force from the desk. The two points, at which luminescence has occurred simultaneously, can be recognized as the same point. As a result, it is possible to perform positioning of the cup 113 covered with the optical fiber sheet relative to the desk covered with the optical fiber.

In the case where the contact state between one object (for example, cup) covered with an optical fiber sheet and the other object (for example, desk) covered with an optical fiber sheet is ambiguous, for example, in the case where the two objects (cup and desk) come into contact with each other at two or more locations although such a case is rare, the target contact location can be estimated among the two or more contact locations by monitoring all the intensities of luminescence from the two or more contact locations, and checking, for each of the two or more contact portions, the luminescence of the stress-luminescent material in the one object (cup) by an acting force given by the other object (desk) and the luminescence of the stress-luminescent material in the other object (desk) by a reaction force given by the one object (cup), thereby performing accurate positioning of the one object (cup) relative to the other object (desk).

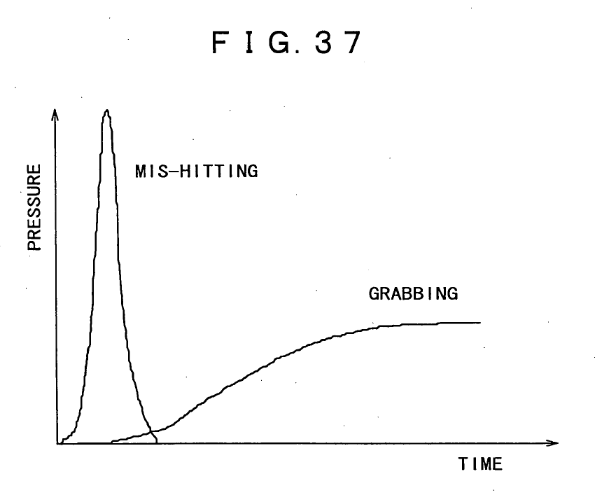

The state analysis can be performed by making use of a change in pressure with elapsed time. For example, a change in pressure with elapsed time very differs between a case where a user erroneously hits his or her hand against a corner of a desk and a case where the user places a notebook type computer on a desk, or between a case where the user hits his or her hand against a cup and a case where the user grabs a cup with-his or her hand for drinking water. FIG. 37 shows a change in pressure with elapsed time, which differs between the grabbing case and the mis-hitting case. In the mis-hitting case, the change in pressure exhibits a steeped curve pattern, whereas in the grabbing case, the change in pressure exhibits a moderate curve pattern.

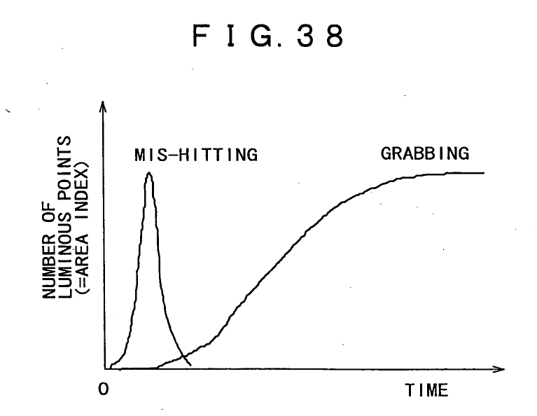

The state analysis can be also performed by making use of a change in the number of luminescence points with elapsed time. For example, a change in the number of luminescence points with elapsed time very differs between a case where a user erroneously hits his or her hand against a corner of a desk and a case where the user places a notebook type computer on a desk, or between a case where the user hits his or her hand against a cup and a case where the user grabs a cup with his or her hand for drinking water. FIG. 38 shows a change in the number of luminescence points with elapsed time, which differs between the grabbing case and the mis-hitting case. In the mis-hitting case, the change in number of the luminescence points exhibits a steeped curve pattern, whereas in the grabbing case, the change in the number of the luminescence points exhibits a moderate curve pattern.

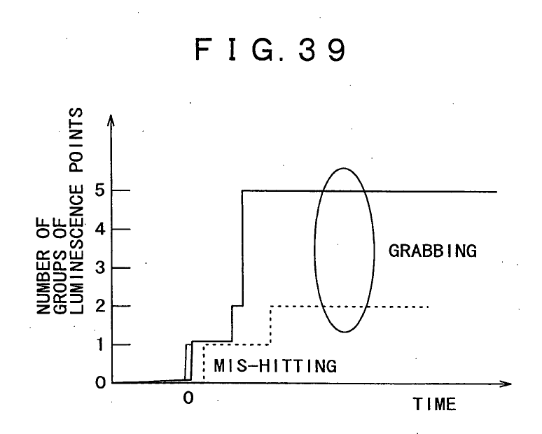

The state analysis can be further performed by making use of the number of groups (or set) of luminescence points. As shown in FIG. 39, the number of groups of luminescence points very differs between a mis-hitting case where the user hits his or her hand against a cup and a grabbing case where the user grabs a cup with his or her hand for drinking water. In the mis-hitting case, only one group of points close to the hit point emit luminescence, whereas in the grabbing case, several groups of points, for example, when meshes of an optical fiber sheet are sufficiently small, a group of points in a thumb region, a group of points in a forefinger region, a group of points in a middle finger region, and a group of points in a ring finger emit luminescence. As a result, the number of groups of luminescence points in the grabbing case is larger than that in the mis-hitting case.

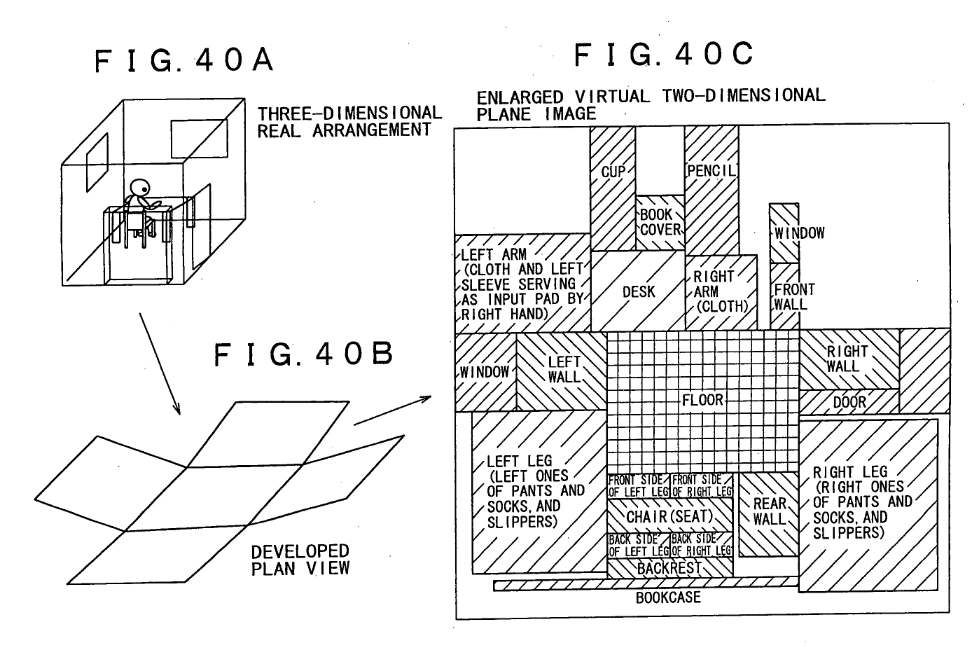

FIGS. 40A to 40C show a fifth embodiment of the present invention.

In the fifth embodiment, as shown in FIGS. 40A to 40C, a three-dimensional space,-which is represented by a room including structures (tools), is converted into an enlarged virtual two-dimensional plane image by attaching optical fiber-sheets similar to those used in the fourth embodiment to the structures in the room. In addition, the optical fiber-sheet used in this embodiment is modified in such a manner that intervals of the meshes of the sheet are adjusted so as to be suitable for the shape and size of each of the structures in the room.

As shown in FIG. 40A, the room has a front wall and a left wall each of which has one window, wherein a bookcase is placed along the rear wall, a desk and a four-leg chair with a backrest are placed in the room, and a user is seated on the chair with his or her back to the bookcase. The optical fiber sheet is stuck on each of these structures. In this case, optical fibers may be knitted in the above structure as needed. Further, the optical fiber sheet is stuck on each of gloves, fingertips (to come into contact with a watch connected to an optical fiber), cloth, pants, socks, slippers, and the other of the user. In this case, optical fibers may be knitted in the above article as needed. Such a three-dimensional real arrangement is developed into a plan view shown in FIG. 40B, and an enlarged virtual two-dimensional plane image shown in FIG. 40C is obtained from the plan view shown in FIG. 40B.

With the use of such an enlarged virtual two-dimensional plane image, an interaction between the user and each of the various tools can be fully monitored by detecting stress-luminescence generated at each of intersection portions between optical fibers of the optical fiber sheets at each contact portion.

The above-described configuration will be more generally and fully described below.

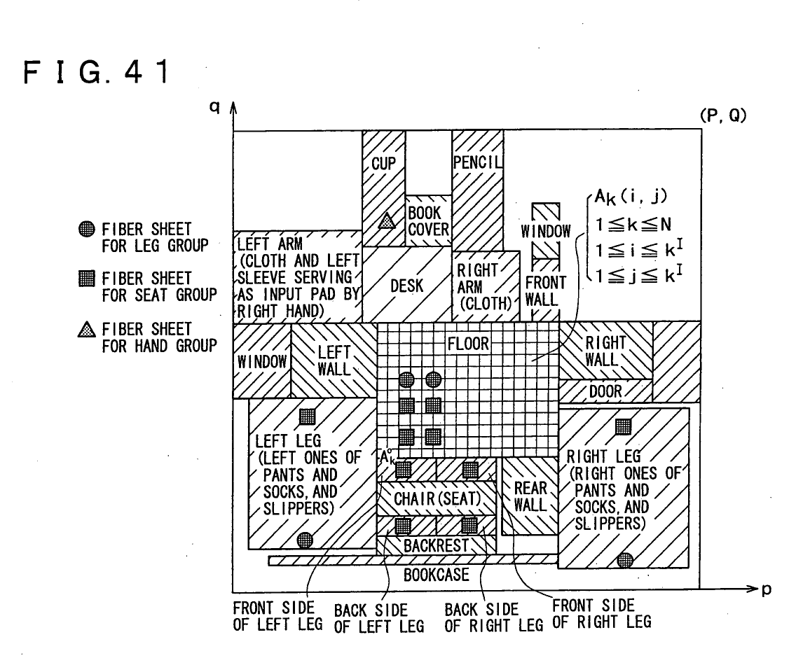

FIG. 41 shows a real space such as a room including tools of the total number of N, wherein the real space is developed into a globally enlarged two-dimensional plane (p, q).

Optical fiber sheets are stuck on the tools of the total number of N, wherein a local mesh of an optical fiber sheet stuck on the k-th tool is expressed by Ak(i, j) on the plane (p, q) shown in FIG. 41, where 1≦k≦N, 1≦i≦k′, and 1≦j≦k′; and 1≦p≦P (=Σₖ₌₁^{N}k′), and 1≦q≦Q (=Σₖ₌₁^{N}k′).

Assuming that the total of the tools is expressed by Sₜₒₜ={(p, q) 1≦p≦P, 1≦q≦Q}, there are given the following equations:
Sₜₒₜ⊃×Uₖ₌₁^{N}{Aₖ(i, j) |1≦i≦k′, 1≦j≦k′}, and
∃i, j, k, ∀vectoim (Sₜₒₜ)=A⁰ₖ+Dₖ (i, j)

In the above equations, Dₖ (i, j) is a local metrical value at the k-th tool, and A⁹ₖ is a coordinate of the original of the local mesh corresponding to the k-th tool on the plane (p, q) indicating Sₜₒₜ.

The information amount of the total of the tools (Sₜₒₜ) becomes about 42 bits as a result of the total of 10 bits for four planes of 256 kinds of the tools, 10 bits for the relative number of originals, 12 bits for 64×64 pieces of local coordinates, 5 bits for local metrical values (for example, 1 mm to 3 cm), and 5 bits for readout of stress. Here, taking into account the allowance, the information amount of the total of the tools (Sₜₒₜ) is set to 64 bits, that is, 8 bytes. If it is sufficient for the sampling rate to be set to 10 ms under the consideration of a time scale of decay of luminescence from SrAl₂O₄, it becomes sufficient for the information readout speed to be set to 800 Bps. As a result, the information readout speed in this processing using the optical fiber sheets is significantly lower than that in general image processing.

In the case of taking up a luminescence state at the moment the user has been seated on the chair as one example of the “state” of the above-described room, as shown in FIG. 41, intersection portions of the optical fiber sheets provided on the floor and back surfaces of the legs of the chair, and leg and foot portions of the user emit luminescence.

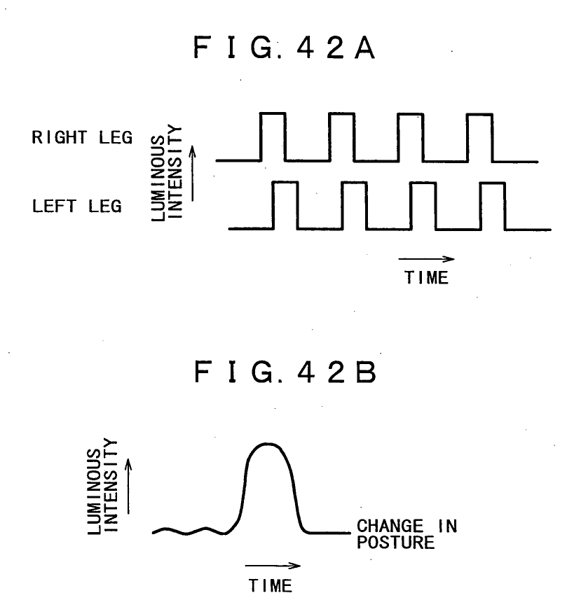

FIG. 42A shows changes in luminescence with elapsed time, the luminescence being emitted from the back surfaces of the socks of the right and left feet of the user walking on the floor.

As typically shown in FIG. 42B, from a luminescence pattern of each of the identified portion, a change in posture or a change in intentional motion, that is, the posture or intentional motion of the user who is walking, sleeping, or reaching his or her hand for a paper coffee cup can be estimated.

The above-described monitoring has a feature that there is no dead zone, unlike visual sensation type information processing such as a video image information processing.

Such monitoring has another feature in making use of metric values of a contact portion, unlike LAN (Local Area Network) based information communication. As a result, it is possible to provide an information processing system previously containing relative positional information and information constrained by a drag.

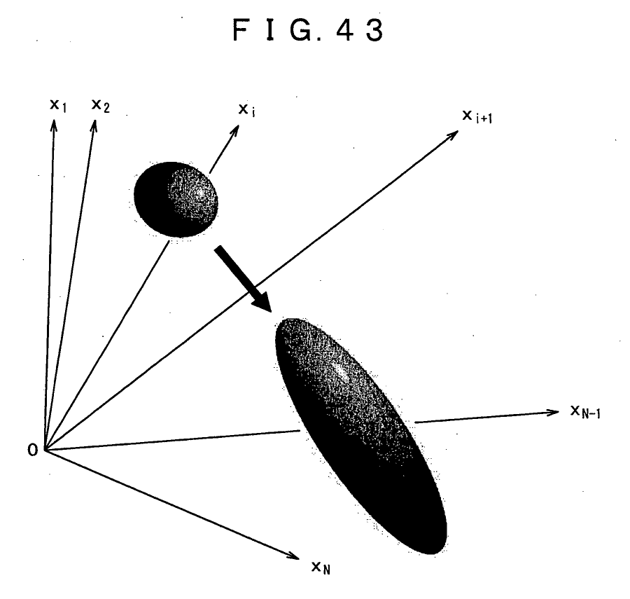

As shown in FIG. 43, changes in position and shape of a manifold in a space of a higher order (n-th order), which changes correspond to changes in correlation of a parameter space, can be estimated by data-processing contact information (mechanical interaction information) among a user, various tools surrounding the user, and an environment. With this configuration, it is possible to perform semantic space information processing and state (situation)-space information processing. In FIG. 43, Xi (i=1 to N) denotes a state vector in the n-th order space, and an ellipsoid denotes the n-th order manifold.

The state analysis according to this embodiment is very different from and superior to the related art state analysis using a video image. This is because, according to the state analysis in this embodiment, the initial setting of a relative position in a constrained information space is previously made on the basis of information at the time of provision of the optical fiber sheets, the information space functions as a metric space, two points acting on each other simultaneously emit luminescence, information on a magnitude of force can be read out, and matching between luminescence from one point receiving an action force from the other point and luminescence from the other point receiving a reaction force from the one point is used as error correction.

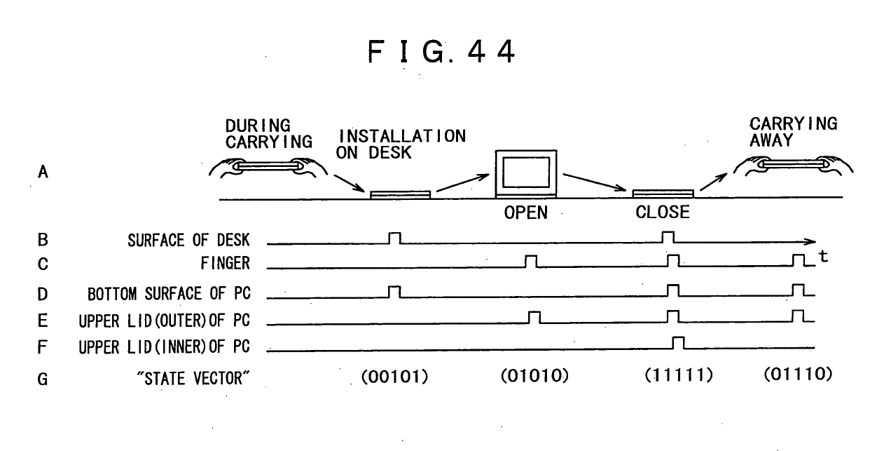

FIG. 44 shows a computing example using a manifold in a space of a higher order (n-th order). The example involves a step of carrying a mobile type personal computer (PC) to a desk, a step of placing the computer on the desk, a step of opening the computer, a step of closing the computer, and a step of carrying away the computer. In these steps, stress-luminescent signals are generated from the surface of the desk, fingers, the back surface of the computer, the top surface of the upper lid of the computer, and the back surface of the upper lid of the computer. For simplicity, one bit is allocated to each structure. On the basis of intensity information and two-dimensional position information, multiple bits may be allocated to each structure. At this time, an event that the computer is placed on the desk is expressed by information of 5 bits, for example, (00101). In general, a state vector X(t)={1010 . . . 1011} is allocated to each of the various events as shown in FIG. 44. To be more specific, the state vector (00101) is allocated to the event that the computer is placed on the desk, the state vector (01010) is allocated to the event that the computer is opened, the state vector (11111) is allocated to the event that the computer is closed, and the state vector (01110) is allocated to the event that the computer is carried away.

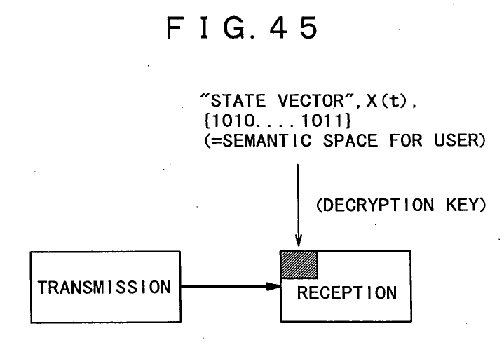

With the use of the above-described technique shown in FIG. 44, as shown in FIG. 45, in-home wireless transmission, for example, transmission from a home server can be performed with the state vector X(t) taken as a decryption key (that is, with the state vector X(t) taken as a flag). In this case, it is impossible to avoid leakage of information to the next home. The state vector X(t) is semantic space information for the user.

On the other hand, computing is executed in digital equipment “i” (inner space of CPU: Yi space), and if an extended computing basis is formed by the state vector X(t) and the inner space Yi, the extended computing basis can be set in such a manner as to perform a certain computing operation only when the user semantic space satisfies a certain requirement. To be more specific, letting Fi be a realization function (calculation in digital space) for a tool “i”, and Yi be the inner space (information processing space) of CPU, {X(t), Yi} can be obtained as the basis of total computing operation of a metric space and a non-metric space. The basis {X(t), Yi} is a matrix (vector) of one-row/n-column, where n=dim (X(t))+dim (Yi). As one application example, when the condition is true, Fi is turned ON. For example, if the condition is that the tool “i” is separated from the user by a distance L or less, when the condition is true, that is, the tool “i” is separated from the user by the distance L or less, the execution of the tool “i” is permitted.

Although the preferred embodiments of the present invention have been described, the present invention is not limited thereto, and it is to be understood that changes and variations may be made without departing from the technical thought of the present invention.

For example, the numeral values, structures, shapes, materials, processes, and the like used in the above-described embodiments are for illustrative purposes only, and therefore, they may be changed as needed without the scope of the present invention.

In the second and third embodiments, the optical fiber 104 is placed on the optical fiber 103; however, the present invention is not limited to such a structure but may be configured such that the optical fibers 103 and 104 may be knitted in the same manner as that used for a general knitted fabric.

The optical fiber sheet according to the present invention can be used, for a bumper of an automobile, as a sensor for acquiring contact information upon backward movement. The optical fiber sheet can be also used as a detector for estimating breakage or distortion of bridges, roofs, and other buildings. In this case, since detection is performed by making use of stress-luminescence, a power for detection is supplied from abnormality such as distortion (and further, the power consumption of a photodetector is very small because the photodetector is operated under a reverse bias mode, with a result that the detector using the optical fiber sheet can be used as a low power consumption system.

By using clothes, gloves, and an intelligent watch coupled fingertip, in each of-.,which the optical fibers according to the present invention are woven, a data base for actions can be established, and finger language or sign language can be automatically translated.

Interaction coordination can be formed by the above-described tactile input system, and on the interaction coordination, higher information processing and higher equipment control can be realized. A system with no dead zone can be in principle established. Even if a point is visually hidden, such a point can be detected insofar as the point keeps interaction with another object.

The optical fiber sheet of the present invention makes it possible to realize integration of a metric space with a non-metric space, and hence to realize a really user friendly Ubiquitous value network (UVN).

The optical fiber sheet of the present invention also makes it possible to realize a Ubiquitous touch sensor (UTS), and a large area correlation processing apparatus and system. Unlike a vision-based cognition and an image information processing, the optical fiber sheet of the present invention can be coupled to a predictive model formed by a computer of a type consuming no memory and can be also coupled to a data base; and is coexistent with data mining. In this way, operation of the optical fiber sheet of the present invention can be combined with higher computing function.

By detecting interaction between optical fibers at a contact portion in a binominal relationship due to occurrence of paired signals, the change in posture or intentional motion can be detected. In the UVN, the state decision ability can be added to the communication ability.

According to the present invention, on-hook information naturally incorporated is taken as flag for communication (as a key). The problem associated with identification of sub-scriber can be solved by releasing scramble on the basis of on-hook information. Also, nuisance communication can be avoided.

With the use of the state decision incorporated with the above-described metric values, digital broadcasting/receipt in in-home LAN can be constrained, to solve the problem associated with leakage of information to the next neighbors.

As described above, according to the present invention, it is possible to provide an optical waveguide, an optical waveguide apparatus, an optomechanical apparatus, a detecting apparatus, an information processing apparatus, an input apparatus, a key-input apparatus, and a fiber structure, each of which is flexible and is applicable to an enlarged structure.

1-66. (canceled)

67. A stress-luminescent composite material sheet having a thickness of less than 1 mm, containing a SrAl₂O₄:Eu powder as a stress-luminescent material and a polyester resin, wherein the content of said stress-luminescent material is in a range of 30 wt % or more and less than 100 wt %.

68. A stress-luminescent composite material sheet according to claim 67, wherein said stress-luminescent composite material sheet emits luminescence depending on a time rate of change of stress.

69. A stress-luminescent composite material sheet according to claim 67, wherein a luminous intensity of said stress-luminescent composite material sheet is changed depending on a time rate of change of stress.

70. A stress-luminescent composite material sheet according to claim 67, wherein said stress-luminescent composite material sheet emits luminescence depending on a speed of applying an external force to said sheet or a speed of releasing the external force.

71. A stress-luminescent composite material sheet according to claim 67, wherein a luminous intensity of said stress-luminescent composite material sheet is changed depending on a speed of applying an external force to said sheet or a speed of releasing the external force.

72. A stress-luminescent composite material sheet according to claim 67, wherein said stress-luminescent composite material sheet emits luminescence when a finger is touched to said sheet.

73. A stress-luminescent composite material sheet according to claim 67, wherein said stress-luminescent composite material sheet emits luminescence when elastic vibration is applied to said sheet.

74. A stress-luminescent composite material sheet according to claim 67, wherein said stress-luminescent composite material sheet emits luminescence when sound waves are applied to said sheet.

75. A stress-luminescent composite material sheet according to claim 67, wherein said stress-luminescent composite material sheet emits luminescence when ultrasonic waves are applied to said sheet.
